(19) United States
(12) Patent Application Publication
(10) Pub. No.: US 2004/0233826 A1
(43) Pub. Date: Nov. 25, 2004

(54) Laser power control device, information recording apparatus, optical disk apparatus, laser power source drive current value determining method, information recording method, optical disk recording method

(76) Inventor: Akihiro Sugano, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/847,616

(22) Filed: May 18, 2004

(30) Foreign Application Priority Data
May 19, 2003 (JP) 2003-140318

(51) Int. Cl. G11B 7/00

(52) U.S. Cl. 369/116

(57) ABSTRACT

A laser power control device controls a light-emitting power of a laser light beam emitted from a laser power source that emits a laser light beam of first power intensity, a laser light beam of second power intensity greater than the first power intensity, and a laser light beam of third power intensity greater than the second power intensity to record information on a recording medium. The laser power control device includes a characteristic obtaining mechanism that obtains a characteristic of the laser power source by causing the laser power source to emit the laser light beam of the second power intensity before recording information on the recording medium, and a current value determining mechanism that determines a value of current required to be supplied to the laser power source to emit the laser light beam of the third power intensity based on the characteristic of the laser power source.

### CROSS-REFERENCE TO RELATED APPLICATIONS

This application claims priority to Japanese Patent Application No. 2003-140318 filed in the Japanese Patent Office on May 19, 2003, the disclosure of which is incorporated herein by reference.

### BACKGROUND OF THE INVENTION

The present invention relates to a laser power control device for use in an optical disk apparatus that records and reproduces information on/from an optical disk, such as a CD-R disk, a CD-RW disk, and a DVD disk by use of a laser. The present invention further relates to an information recording apparatus using the laser power control device, and to an optical disk apparatus that records and reproduces information on/from an optical disk, such as, a CD-R disk, a CD-RW disk, and a DVD disk. The present invention further relates to a method of determining a value of current supplied to a laser power source that emits a laser light beam to record and reproduce information on/from a recording medium, such as, a CD-R disk, a CD-RW disk, and a DVD disk. The present invention further relates to a method of recording information on a recording medium, such as a CD-R disk, a CD-RW disk, and a DVD disk, and to a method of recording information on an optical disk, such as, a CD-R disk, a CD-RW disk, and a DVD disk.

In a conventional optical disk apparatus, such as a CD-R drive and a CD-RW drive, which records and reproduces information data into/from an optical disk, a bias power current is calculated from a reproduction power current control value of a servo amplifier for the reproduction immediately before recording, an erase power is detected by a sample-hold circuit, and the emission of a laser light beam is controlled based on the detected value. Further, a peak power is calculated from an erase power current. This technology is described, for example, in Published Japanese Patent application No. 2001-229561.

However, in such a conventional optical disk apparatus, the peak power calculated from the erase power current varies due to the variation of the erase power obtained by a sample-holding operation.

Generally, in an optical disk apparatus, before recording information data into an optical disk, a so-called optimum power control (OPC) needs to be performed to determine an optimum intensity value of a recording power of a laser light beam. When performing an OPC operation, test data is recorded on a test area of an optical disk by variously changing an intensity value of a recording power of a laser light beam emitted from a laser power source step by step from a minimum intensity value to a maximum intensity value. The intensity value of the recording power of the laser light beam that provides a highest recording quality is detected by reproducing the recorded test data, and is determined as an optimum intensity value of the recording power of the laser light beam. In such an OPC operation, if a recording power of a laser light beam varies when recording test data on a test area of an optical disk, an optimum intensity value of a recording power of a laser light beam cannot be adequately determined.

### BRIEF SUMMARY OF THE INVENTION

According to an aspect of the present invention, a laser power control device controls a light-emitting power of a laser light beam emitted from a laser power source that emits at least a laser light beam of first power intensity, a laser light beam of second power intensity greater than the first power intensity, and a laser light beam of third power intensity greater than the second power intensity to record information data into a recording medium. The laser power control device includes a characteristic obtaining mechanism configured to obtain a characteristic of the laser power source by causing the laser power source to emit the laser light beam of the second power intensity before recording information data into the recording medium, and a current value determining mechanism configured to determine a value of current required to be supplied to the laser power source to emit the laser light beam of the third power intensity from the laser power source based on the characteristic of the laser power source obtained by the characteristic obtaining mechanism.

According to another aspect of the present invention, an information recording apparatus that records information data into a recording medium by emitting a laser light beam to the recording medium, includes a laser power source configured to emit at least a laser light beam of first power intensity, a laser light beam of second power intensity greater than the first power intensity, a laser light beam of third power intensity greater than the second power intensity to the recording medium, and the above-described laser power control device.

According to another aspect of the present invention, an optical disk apparatus includes a laser diode configured to emit a digitally modulated laser light beam to an optical recording medium including a light-emitting power calibration area that is used for determining an optimum recording power intensity value of the laser light beam emitted from the laser diode, a test area including a plurality of partitions into which test data is recorded and a count area including a plurality of partitions corresponding to the partitions of the test area. The laser light beam emitted from the laser diode includes a laser light beam of first power intensity, a laser light beam of second power intensity greater than the first power intensity, and a laser light beam of third power intensity greater than the second power intensity. The optical disk apparatus further includes a laser diode drive mechanism configured to drive the laser diode by supplying current to the laser diode, and a light-emitting power detecting mechanism configured to detect a light-emitting power of the laser light beam emitted from the laser diode. The optical disk apparatus also includes a power intensity adjusting mechanism configured to adjust a power intensity of the laser light beam emitted from the laser diode based on the light-emitting power detected by the light-emitting power detecting mechanism by changing a value of the current supplied to the laser diode by the laser diode drive mechanism. In addition, an optimum recording power intensity value determining mechanism is configured to determine the optimum recording power intensity value of the laser light beam emitted from the laser diode by recording the test data into one of the partitions of the test area while changing the light-emitting power of the laser light beam emitted from the laser diode, and by reproducing the test data. Also included is a characteristic obtaining mechanism configured to obtain a characteristic of the laser diode by causing the laser diode to emit the laser light beam of the second power intensity to the one of the partitions of the test area before recording the test data into the one of the partitions. The light-emitting power of the laser light beam emitted from the laser diode when recording the test data into the one of the partitions of the test area is obtained based on the characteristic of the laser diode obtained by the characteristic obtaining mechanism.

According to yet another aspect of the present invention, a method of determining a value of current supplied to a laser power source that emits at least a laser light beam of first power intensity, a laser light beam of second power intensity greater than the first power intensity, and a laser light beam of third power intensity greater than the second power intensity to record information data into a recording medium, includes obtaining a characteristic of the laser power source by causing the laser power source to emit the laser light beam of the second power intensity before recording information data into the recording medium, and determining a value of current required to be supplied to the laser power source to emit the laser light beam of the third power intensity from the laser power source based on the characteristic of the laser power source.

According to yet another aspect of the present invention, a method of recording information data into a recording medium by emitting a laser light beam to the recording medium from a laser power source that emits at least a laser light beam of first power intensity, a laser light beam of second power intensity greater than the first power intensity, and a laser light beam of third power intensity greater than the second power intensity, includes obtaining a characteristic of the laser power source by causing the laser power source to emit the laser light beam of the second power intensity before recording information data into the recording medium, determining a value of current required to be supplied to the laser power source to emit the laser light beam of the third power intensity from the laser power source based on the characteristic of the laser power source; and emitting the laser light beam to the recording medium from the laser power source while supplying the current of the determined value to the laser power source.

According to yet another aspect of the present invention, a method of recording information data into an optical recording medium by emitting a digitally modulated laser light beam to the optical recording medium from a laser diode that emits at least a laser light beam of first power intensity, a laser light beam of second power intensity greater than the first power intensity, and a laser light beam of third power intensity greater than the second power intensity, includes obtaining a characteristic of the laser diode by causing the laser diode to emit the laser light beam of the second power intensity to one of partitions of a test area of the optical recording medium. An optimum recording power intensity value of a laser light beam emitted from the laser diode is determined by recording a test data into the one of partitions of the test area while changing a light-emitting power of the laser light beam emitted from the laser diode, and by reproducing the test data. The light-emitting power of the laser light beam emitted from the laser diode when recording the test data into the one of the partitions of the test area is obtained based on the characteristic of the laser diode. The method further includes driving the laser diode by supplying current to the laser diode; detecting a light-emitting power of the laser light beam emitted from the laser diode; and adjusting a power intensity of the laser light beam emitted from the laser diode based on the detected light-emitting power by changing a value of the current supplied to the laser diode.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 is a diagram for explaining a laser light beam emitted from a laser power source to a CD-RW disk according to an embodiment of the present invention;

FIG. 2 is a block diagram of a circuit of a laser controller as a laser power control device that performs a constant power control of a light emission to a CD-RW disk;

FIG. 3 is a waveform showing a relation between a voltage value Vs(P1) output from a first sample-hold (S/H) circuit and an output of a first comparator in a digital control;

FIG. 4 is a waveform showing a relation between a voltage value Vs(P2) output from a second sample-hold (S/H) circuit and an output of a second comparator in a digital control;

FIG. 5 is a characteristic diagram showing a relation between a current value for driving a laser diode and a light-emitting power of the laser diode;

FIG. 6A is a diagram showing a cross section taken along a radial direction of an optical disk;

FIG. 6B is a diagram showing a test area and a count area in a power calibration area;

FIG. 7 is a block diagram of a configuration of an optical disk apparatus according to an embodiment of the present invention;

FIG. 8 is a block diagram of a configuration of an information processing system including the optical disk apparatus of FIG. 7;

FIG. 9 is a diagram showing a structure of a recording area of an optical disk; and

FIG. 10 is a flowchart of laser power control operation steps of a CPU according to an embodiment of the present invention.

### DETAILED DESCRIPTION OF THE INVENTION

Preferred embodiments of the present invention are described in detail referring to the drawings, wherein like reference numerals designate identical or corresponding parts throughout the several views.

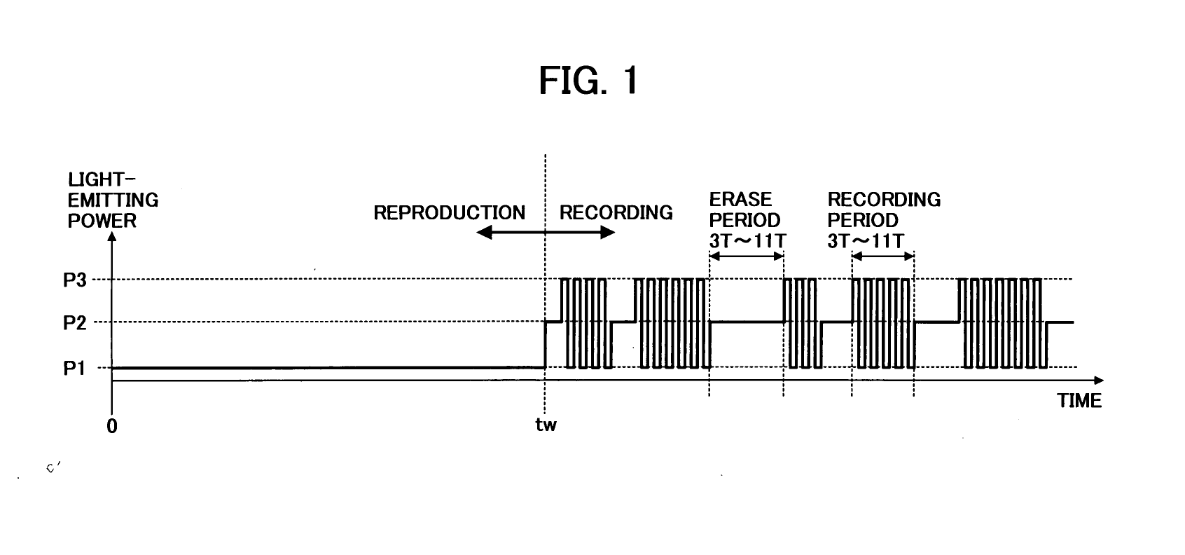

First, a basic technique of the present invention will be described. FIG. 1 is a diagram for explaining a laser light beam emitted from a laser power source to a CD-RW disk.

When recording information data into an optical recording medium, for example, into a CD-R disk, in an optical disk apparatus, a laser beam of high power intensity is emitted from a laser diode (hereafter referred to as an “LD”) as a laser power source and is radiated to a recording film of the CD-R disk. Thereby, marks (pits) are formed on the CD-R disk by a thermo-reaction. When recording information data into a CD-RW disk, the phase of a recording film of the CD-RW disk is changed.

The information data recorded into the optical recording medium is read out based on an amount of reflected light obtained by irradiating the recording film of the optical recording medium with a laser beam of low power intensity emitted from the LD. Generally, to change the phase of a recording film of a CD-RW disk, a laser light beam is emitted from an LD in a manner shown in FIG. 1. In FIG. 1, a period from a time “0” to a time “tw” represents a reproduction state, and a time elapsed since the time “tw” represents a state after the start of recording. As shown in FIG. 1, a laser light beam of first power intensity P1 is emitted in the reproduction state. The light-emitting power of the laser light beam of the first power intensity P1 is low, for example, about 1 mW.

In this embodiment, the first power intensity P1 is kept equal in the reproduction state and the state after the start of recording. However, the first power intensity P1 may be changed. After the start of recording, the recording film of the CD-RW disk is made amorphous by recording while emitting a laser light beam varied between third power intensity P3 and the first power intensity P1 at a high speed. Hereafter, a light-emitting period in which the recording film of the CD-RW disk is made amorphous will be referred to as a “recording period”. Further, the recording film of the CD-RW disk is made crystalline by recording while emitting a laser light beam of second power intensity P2 continuously. In this case, the second power intensity P2 of the laser light beam functions as a DC erase power. Hereafter, a light-emitting period in which the recording film of the CD-RW disk is made crystalline will be referred to as an “erase period”.

As described above, the weak laser light beam of the first power intensity P1 is emitted in the reproduction state. The light radiated to amorphous portions of the recording film is not reflected. This condition is similar to a case in which marks (pits) are formed on a CD-R disk. On the other hand, when the weak laser light beam of the first power intensity P1 is radiated to crystalline portions of the recording film, the light is reflected back. This condition is similar to a case in which marks (pits) are not formed on a CD-R disk. In the erase period, when the laser light beam of the second power intensity P2 (i.e., the laser light beam of the DC erase power) is radiated to crystalline portions of the recording film, the crystalline portions of the recording film are kept crystalline. On the other hand, when the laser light beam of the second power intensity P2 (i.e., the laser light beam of the DC erase power) is radiated to amorphous portions of the recording film, the amorphous portions of the recording film are changed to crystalline portions.

Each of the recording period and the erase period has a time length in a range of 3T to 11T according to speed. In the recording period, as described above, emissions of laser light beams of the third power intensity P3 and the first power intensity P1 are repeated at a high speed. Generally, a period of emitting a laser light beam of the third power intensity P3 and a period of emitting a laser light beam of the first power intensity P1 are preset for each optical disk. In addition, a power intensity value between the second power intensity P2 and the first power intensity P1 and a power intensity value between the third power intensity P3 and the first power intensity P1 are preset for each optical disk.

Recently, a recording speed has been increasing. For example, a recording speed of a CD-RW disk is 16 times speed (16×). Generally, the light-emitting power of the laser light beam of the first power intensity P1 is in a range of about 1 mW to about 2 mW. The light-emitting power of the laser light beam of the second power intensity P2 is in a range of about 5 mW to about 20 mW. The light-emitting power of the laser light beam of the third power intensity P3 is in a range of about 10 mW to about 40 mW. Generally, in a CD-RW disk, a laser light beam varied between two different power intensity values is emitted in the recording period, and a laser light beam of one power intensity value is emitted in the erase period as described above. The light-emitting power of an LD typically varies due to a temperature rise caused by its oscillation. In particular, if the light-emitting power of an LD is high, the temperature of the LD rises in a short period of time as compared to a low light-emitting power. Therefore, it is necessary to keep a light-emitting power of an LD at a constant value by controlling a current for driving the LD while monitoring the output of the LD with a light-receiving element in an optical disk apparatus.

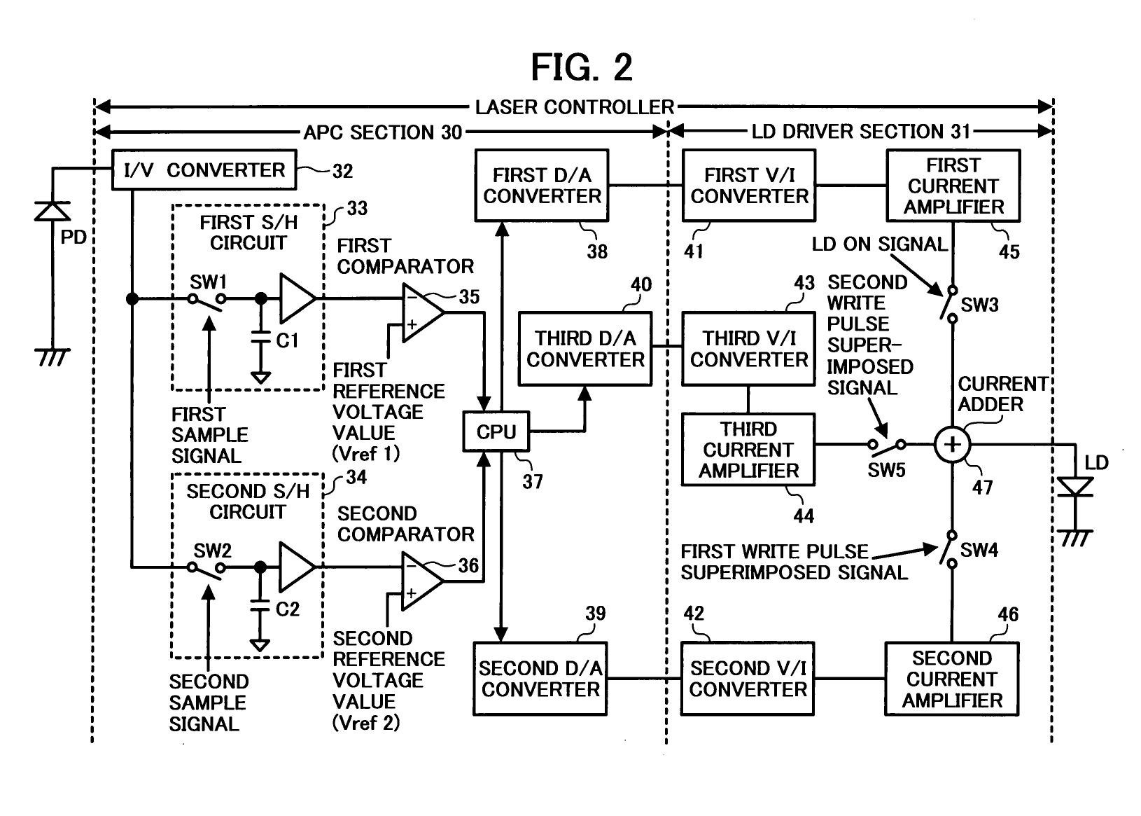

FIG. 2 is a block diagram of a circuit of a laser controller as a laser power control device that performs a constant power control of a light beam emission to a CD-RW disk. In FIG. 2, a photodiode (PD) is a light-receiving element. The light incident on the PD is converted to a current in proportion to an intensity of the light by a photoelectric conversion. The PD monitors a part of a laser light beam emitted from the LD, and a large amount of the emitted laser light beam is radiated to a recording film of the CD-RW disk. In this embodiment, the PD functions as a light-emitting power detecting mechanism that detects a light-emitting power of a laser light beam emitted from the LD. Next, an I/V converter (I/V conversion circuit) 32 converts the current value output from the PD to a voltage value.

With respect to voltage values output from the I/V converter 32, a voltage value obtained by converting a current value corresponding to the laser light beam of the first power intensity P1 at the time of reproduction is set as a voltage value V(P1), and a voltage value obtained by converting a current value corresponding to the laser light beam of the second power intensity P2 in the erase period at the time of recording is set as a voltage value V(P2).

The laser controller includes a first sample-hold (S/H) circuit 33 that samples and holds the voltage value V(P1) at the time of reproduction, and a second sample-hold (S/H) circuit 34 that samples and holds the voltage value V(P2) in the erase period at the time of recording. The reason why two sample-hold circuits are provided is as follows. Because there is a power difference between the laser light beam of the first power intensity P1 and the laser light beam of the second power intensity P2, if a common sample-hold circuit samples and holds the voltage value V(P1) and the voltage value V(P2), the sampled and held voltage value V(P1) becomes substantially small. Therefore, in the first sample-hold (S/H) circuit 33, the sampled and held voltage value V(P1) is amplified with a predetermined gain which is different from a gain used for amplifying the sampled and held voltage value V(P2) in the second sample-hold (S/H) circuit 34.

Generally, an optical disk apparatus is configured to record information data into not only a CD-RW disk but also a CD-R disk. In the case of recording information data into the CD-R disk, two sample-hold (S/H) circuits are used for sampling and holding not only the voltage value V(P2) but also the voltage value V(P1) after the start of recording. A detail description of the CD-R disk will be omitted here.

As described above, the first sample-hold (S/H) circuit 33 samples the voltage value V(P1) at the time of reproduction. At the time of reproduction, a first sample signal in the first sample-hold (S/H) circuit 33 constantly turns on a switch (SW1) in the first sample-hold (S/H) circuit 33. Further, the first sample signal constantly turns off the switch (SW1) during the recording period after the start of recording information data into the CD-RW disk. Because a laser light beam of the third power intensity P3 and a laser light beam of the first power intensity P1 are emitted alternately at a high speed during the recording period, the period of the emission of the laser light beam of the first power intensity P1 is too short. Therefore, the first sample-hold (S/H) circuit 33 cannot sample and hold the voltage value V(P1) in the recording period. A second sample signal in the second sample-hold (S/H) circuit 34 constantly turns off a switch (SW2) in the second sample-hold (S/H) circuit 34 at the time of reproduction. After the start of recording, the switch (SW2) in the second sample-hold (S/H) circuit 34 is turned on in the erase period (i.e., the period in which the laser light beam of the second power intensity P2 is emitted) or in a period shorter than the erase period. In the recording period, the switch (SW2) in the second sample-hold (S/H) circuit 34 is turned off. Thus, the second sample signal is a control signal for taking out only a voltage value Vs(P2) corresponding to the laser light beam of the second power intensity P2 in a condenser C2 in the second sample-hold (S/H) circuit 34.

A voltage value Vs(P1) output from the first sample-hold (S/H) circuit 33 at the time of reproduction, and the voltage value Vs(P2) output from the second sample-hold (S/H) circuit 34 after the start of recording, are input to a first comparator 35 and a second comparator 36, respectively. The first comparator 35 compares the voltage value Vs(P1) with a first reference voltage value (Vref1), and the second comparator 36 compares the voltage value Vs(P2) with a second reference voltage value (Vref2). Each of the first comparator 35 and the second comparator 36 determines if a value of an input signal exceeds a reference voltage value, and outputs signals of a comparison result, that is, binary signals (digital data). Subsequently, a central processing unit (CPU) 37 reads the digital data. Then, the digital data is transmitted from the CPU 37 to a first D/A converter 38 that converts a digital value to an analog value. The first D/A converter 38 outputs a voltage value in proportion to the digital data input thereto to a first V/I converter 41. Further, the first V/I converter 41 outputs a current value according to the voltage value output from the first D/A converter 38.

Likewise, digital data is transmitted from the CPU 37 to a second D/A converter 39. The second D/A converter 39 outputs a voltage value in proportion to the digital data input thereto to a second V/I converter 42. Further, the second V/I converter 42 outputs a current value according to the voltage value output from the second D/A converter 39.

Further, current values output from the first V/I converter 41 and the second V/I converter 42 are amplified by a first current amplifier 45 and a second current amplifier 46, respectively. At the time of reproduction, the output current of the first current amplifier 45 is supplied to an LD by turning on a switch SW3 by a light source on signal (LD ON signal), and thereby the LD emits a laser light beam of the first power intensity P1. After the start of recording, the output current of the second current amplifier 46 is added to the output current of the first current amplifier 45 by a current adder 47 by turning on a switch SW4 by a first write pulse superimposed signal, and is supplied to the LD. Then, the LD emits a laser light beam of the second power intensity P2. Here, a current value output from the first current amplifier 45 is referred to as “IP1”, and a current value output from the second current amplifier 46 is referred to as “IP2”.

The laser controller keeps the light-emitting power of the LD at a constant level in a manner described below.

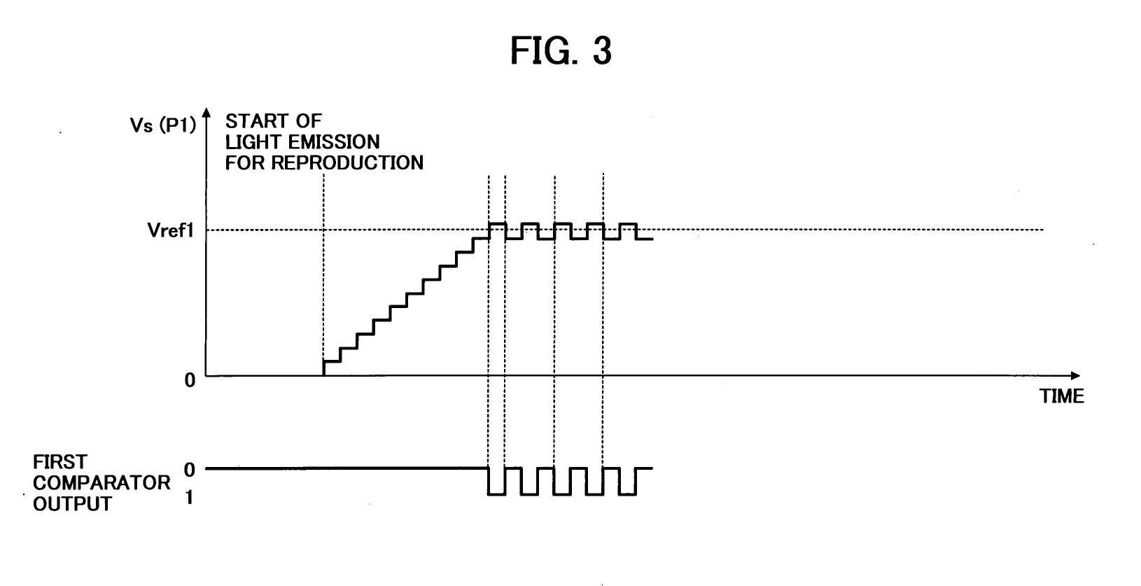

First, at the time of start of reproduction, the CPU 37 outputs “0” to the first D/A converter 38. Thereby, a current value for a reproduction power of the LD starts from “0”. Then, the CPU 37 gradually increases data to be output to the first D/A converter 38 until the output of the first comparator 35 is inversed, that is, until the voltage value Vs(P1) exceeds the first reference voltage value Vref1. Subsequently, the data output from the CPU 37 to the first D/A converter 38 is adjusted such that the voltage value Vs(P1) becomes close to the first reference voltage value Vref1. FIG. 3 is a waveform showing a relation between the voltage value Vs(P1) output from the first sample-hold (S/H) circuit 33 and an output of the first comparator 35 in a digital control. As shown in FIG. 3, the reproduction power of the LD is kept at a constant level by performing the above-described digital control. As an ideal condition, it is preferable that the voltage value Vs(P1) becomes equal to the first reference voltage value Vref1. However, in reality, the voltage value Vs(P1) exceeds and falls below the first reference voltage value Vref1 as shown in FIG. 3.

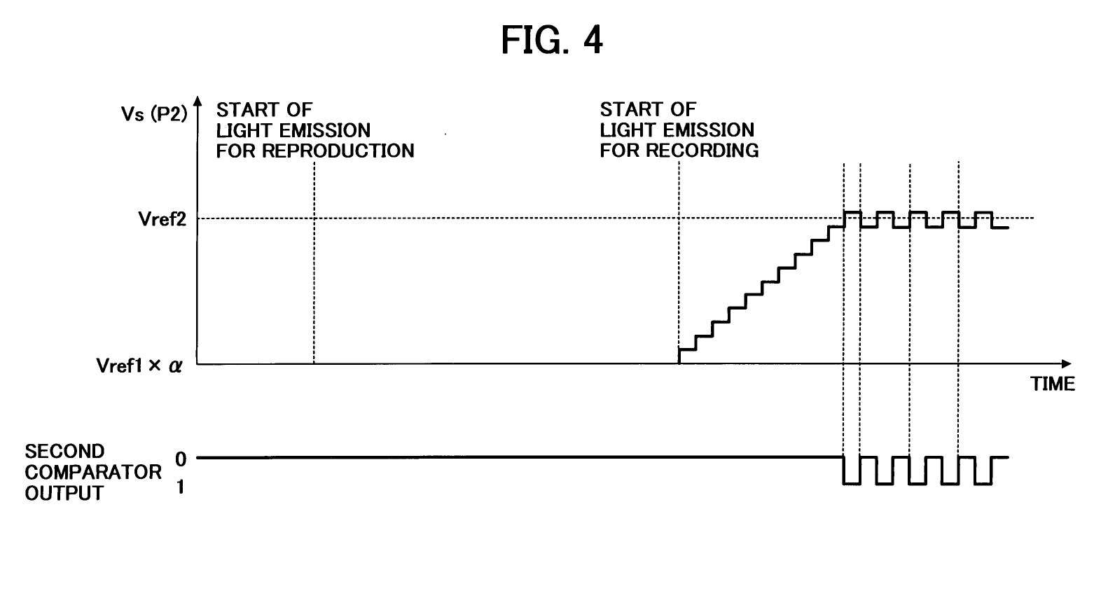

FIG. 4 is a waveform showing a relation between the voltage value Vs(P2) output from the second sample-hold (S/H) circuit 34 and an output of the second comparator 36 in a digital control. Specifically, FIG. 4 shows a state in which the laser light beam of the first power intensity P1 emitted from the LD at the time of reproduction changes to the laser light beam of the second power intensity P2 and is kept at a constant level after the start of recording. In FIG. 4, the CPU 37 sets the output of the second D/A converter 39 at “0” at the time of a light emission for reproduction. The voltage value Vs(P2) output from the second sample-hold (S/H) circuit 34 just after the start of recording is substantially equal to the voltage value Vs(P1) output from the first sample-hold (S/H) circuit 33 at the time of reproduction. As shown in FIG. 4, the first reference voltage value Vref1 is multiplied by “α” as a difference of gain in the path. Generally, the value of “α” is set to be less than “1”.

Then, the CPU 37 increases data to be output to the second D/A converter 39 by “1” or a predetermined value. The current value according to the voltage value output from the second D/A converter 39 is superimposed on the current value according to the voltage value output from the first D/A converter 38 as a current value for an erase power of the LD. Accordingly, the voltage value Vs(P2) output from the second sample-hold (S/H) circuit 34, which are obtained by monitoring, sampling, and holding the current value for the erase power of the LD, increases by a predetermined amount such that the voltage value Vs(P2) becomes close to the second reference voltage value Vref2 as shown in FIG. 4. Subsequently, as shown in FIG. 4, the erase power of the LD is kept at a constant level as was done similarly at the time of reproduction. As an ideal condition, it is preferable that the voltage value Vs(P2) becomes equal to the second reference voltage value Vref2. However, in reality, the voltage value Vs(P2) exceeds and falls below the second reference voltage value Vref2 as shown in FIG. 4.

As described above, the voltage of the laser light beam of the first power intensity P1 is not sampled and held after the start of recording. The output value of the first D/A converter 38 at the start of recording may be set to the output value of the first D/A converter 38 just before the start of recording. Specifically, the laser light beam of the first power intensity P1 has a low light-emitting power, and the LD emits the laser light beam of the first power intensity P1 only in the recording period after the start of recording. The laser light beam of the first power intensity P1 is intermittently emitted from the LD, and is not influenced much by the variation of the light emission of the LD caused by its temperature. Therefore, the output value of the first D/A converter 38 may be set to a constant value. Thus, the laser light beam of the first power intensity P1 may be emitted from the LD at a constant level in the recording period after the start of recording.

In the above-described circuit of the laser controller, a digital control is performed by using the CPU 37 and the D/A converters at the time of reproduction and recording. In place of the digital control, an analog control may be employed to perform a constant power control. For example, in the analog control, a signal output from a first sample-hold (S/H) circuit or a signal output from a second sample-hold (S/H) circuit is input to an error amplifier, such as, an integrator. In the error amplifier, a value of the signal is compared with a reference voltage value. If the value of the signal is different from the reference voltage value, the error amplifier outputs a voltage value for adjusting the difference between the value of the signal and the reference voltage value to a first V/I converter or a second V/I converter.

Because the laser light beam of the first power intensity P1 has a low light-emitting power, even though the analog control is performed, the voltage value output from the error amplifier does not vary significantly just after the start of reproduction. Further, in the analog control, a period of time necessary for making the light-emitting power constant is shorter than that in the digital control. For these reasons, the laser light beam of the first power intensity P1 is often controlled by the analog control at the time of reproduction.

When controlling the laser light beam of the first power intensity P1 by the analog control, a signal output from the first sample-hold (S/H) circuit is input to the error amplifier. Then, a voltage value output from the error amplifier is directly input to the first V/I converter. In addition, it is configured such that the voltage value output from the first D/A converter is input to the first V/I converter. A switch may be provided to switch the input to the first V/I converter either from the error amplifier or from the first D/A converter. Further, it may be configured such that an A/D converter may check the output level of the error amplifier when the emitting power of the laser light beam of the first power intensity P1 is made at a constant level at the time of reproduction. After the start of recording, a voltage value output from the first D/A converter in the digital control is made equal to the voltage value output from the error amplifier in the analog control.

Thus, a laser power control operation is similarly performed in both the analog control and the digital control. Specifically, the light-emitting power of the LD is monitored. Then, a voltage value corresponding to a laser light beam of a predetermined intensity is compared with a reference voltage value. Then, a drive current value to be input to the LD is controlled such that the voltage value corresponding to the laser light beam of the predetermined intensity becomes close to (ideally, equal to) the reference voltage value.

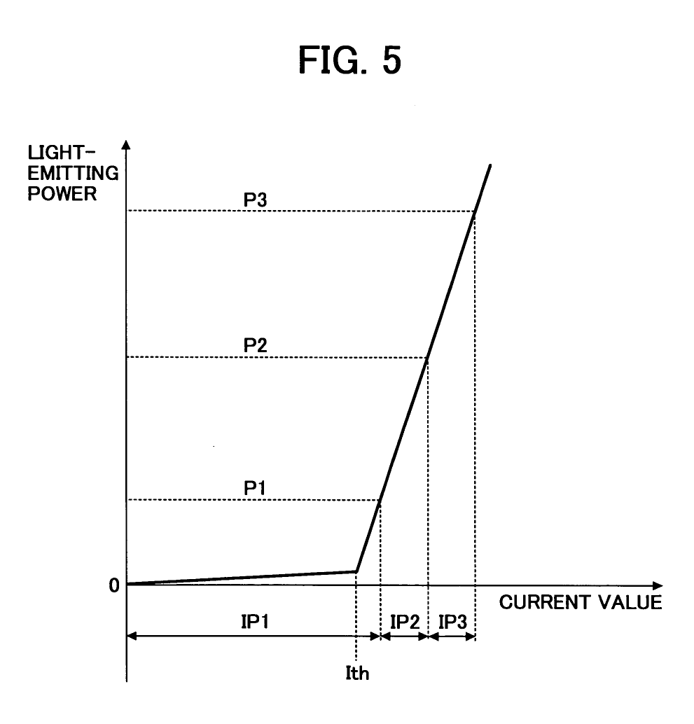

FIG. 5 is a characteristic diagram showing a relation between a current value for driving the LD and the light-emitting power of the LD. As shown in FIG. 5, there is a linear functional relation between the current value for driving the LD and the light-emitting power of the LD when the current value exceeds a threshold value “Ith”. The slope of the line segment may vary depending on an LD. Because the light-emitting power of the LD has a specific relation relative to the current value for driving the LD, the light-emitting power of the LD also has a specific relation relative to the voltage value set at the D/A converter for setting the current value for driving the LD. Further, because the voltage value set at the D/A converter for setting the current value for driving the LD is determined based on the reference voltage value of the comparator, there is a linear functional relation between the reference voltage value of the comparator and the light-emitting power of the LD with a predetermined slope.

Therefore, if the slope is calculated in advance, the light-emitting power of the LD is obtained from the reference voltage value. If a slope or an intercept of the line is stored in a memory, the light-emitting power of the LD is controlled efficiently. Usually, the relation between the reference voltage value of the comparator and the first power intensity P1 or the second power intensity P2 is obtained in advance, for example, as a relational expression in a production process of an optical disk apparatus. When emitting a laser light beam from an LD in an actual operation of the optical disk apparatus, the first power intensity P1 and the second power intensity P2 are set by the relational expression.

Although the above-described slope of the line segment varies depending on characteristics of an LD, such as a temperature, and the threshold value “Ith” shifts, the CPU 37 controls the light-emitting power of the LD at a constant level by adjusting a current value for driving the LD (i.e., a current value output from the V/I converter) such that the voltage value output from the sample-hold (S/H) circuit becomes close to the reference voltage value of the comparator.

Generally, a control for keeping a light-emitting power of an LD at a constant level is referred to as an auto power control (APC). As described above, after the start of recording information (data) into the CD-RW disk, because the laser light beam of the first power intensity P1 has a low light-emitting power, and is intermittently emitted from the LD, the laser light beam of the first power intensity P1 is not sampled and held, so that the laser light beam of the first power intensity P1 emitted after the start of recording is not subjected to the APC. Only the laser light beam of the second power intensity P2 (i.e., an erase power) is subjected to the APC after the start of recording.

Next, a control for an emission of a laser light beam of the third power intensity P3 will be described.

As described above, when recording and reproducing information data into/from a CD-RW disk, three different intensity values of light-emitting powers (power levels) are used. That is, the first power intensity P1, the second power intensity P2, and the third power intensity P3. When emitting the laser light beam of the third power intensity P3 from the LD, an output current of a third current amplifier 44 is added to the output current of the first current amplifier 45 and the output current of the second current amplifier 46 by the current adder 47 by turning on a switch SW5 by a second write pulse superimposed signal, and is supplied to the LD. Then, the LD emits a laser light beam of the third power intensity P3. Here, a current value output from the third current amplifier 44 is referred to as “IP3”.

In FIG. 5, a first current value required to be supplied to the LD for emitting a laser light beam at a power level of the first power intensity P1 is indicated by “IP1”, a second current value required to be supplied to the LD for emitting a laser light beam at a power level of the second power intensity P2 is indicated by “IP2”, and a third current value required to be supplied to the LD for emitting a laser light beam at a power level of the third power intensity P3 is indicated by “IP3”. Specifically, when supplying a current value (IP1) to the LD, the LD emits the laser light beam of the first power intensity P1. When supplying a current value (IP1+IP2) to the LD, the LD emits the laser light beam of the second power intensity P2. When supplying a current value (IP1+IP2+IP3) to the LD, the LD emits the laser light beam of the third power intensity P3.

The second power intensity P2 is controlled such that the voltage value input to the second comparator 36 becomes close to (ideally, equal to) the second reference voltage value Vref2 by changing the second current value IP2 (i.e., the voltage value set at the second D/A converter 39) by the APC. As provided similarly in connection with the laser light beam of the first power intensity P1, the laser light beam of the third power intensity P3 is intermittently emitted from the LD only in the recording period after the start of recording. Therefore, it is difficult to sample and hold the laser light beam of the third power intensity P3. For this reason, a voltage value set at a third D/A converter 40 is input to a third V/I converter 43. Then, the output current of the third V/I converter 43 becomes the third current value IP3.

The third power intensity P3 has a substantially greater power than the first power intensity P1. For example, the third power intensity P3 may have about double the power of the second power intensity P2. When emitting the laser light beam of the third power intensity P3 from the LD, the output of the LD varies due to the increase of the temperature of the LD. In this condition, even if the third current value IP3 for driving the LD is unchanged, the third power intensity P3 of the laser light beam emitted from the LD changes. For these reasons, the laser light beam of the third power intensity P3 needs to be controlled. The power level of the third power intensity P3 is maintained by changing the third current value IP3 in the following manner.

As shown in FIG. 5, there is a linear functional relation between the current value for driving the LD and the light-emitting power of the LD. Assuming that the slope of the line is constant when the current value exceeds the threshold value “Ith”, the slope obtained from the second current value IP2 and the second power intensity P2 may be considered as a laser efficiency value, that is, a ratio between the current value and the light-emitting power. The laser efficiency value (i.e., the slope) is unchanged unless the light-emitting power of the LD is close to an upper limit. In the case of recording data into the CD-RW disk, the light-emitting power of an LD does not generally approach the upper limit. Specifically, the third current value IP3 is determined as follows.

First, a laser efficiency value EV1 is obtained by the following equation,

EV1=(P2−P1)/IP2 (1)

where P2 is the second power intensity, P1 is the first power intensity, and IP2 is the second current value.

The laser efficiency value EV1 is obtained by the above equation because the current value for driving the LD and the light-emitting power of the LD are directly proportional when the current value exceeds the threshold value “Ith” as shown in FIG. 5.

Next, the third current value IP3 required to be supplied to the LD to emit a laser light beam at a power level of the third power intensity P3 is determined by the following equation,

IP3=(P3−P2)/EV1 (2)

where P3 is the third power intensity, P2 is the second power intensity, and EV1 is the laser efficiency value obtained by the equation (1).

As described above, the first power intensity P1, the second power intensity P2, and the third power intensity P3 are preset as target power intensity values. On the other hand, the second current value IP2 varies by being subjected to the automatic power control (APC). The value of the third power intensity P3 is maintained by adjusting the third current value IP3 based on the varied second current value IP2.

Before recording information data into an optical disk, a so-called optimum power control (OPC) needs to be performed to determine an optimum intensity value of a recording power of a laser light beam. Such an OPC needs to be performed because an optimum intensity value of a recording power of a laser light beam varies depending on factors, such as a recording sensitivity of an optical disk, a laser wavelength, a recording wavelength, and a temperature.

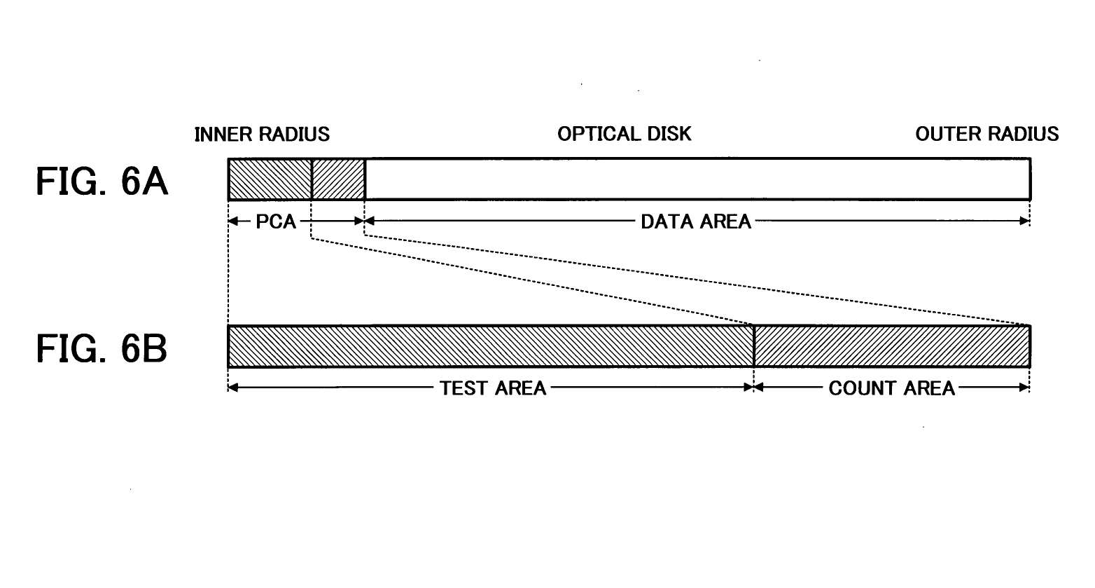

FIG. 6A is a diagram showing a cross section taken along a radial direction of an optical disk. FIG. 6B is a diagram showing a test area and a count area in a power calibration area. As shown in FIG. 6A, the optical disk includes a power calibration area (PCA) where the OPC is performed, and a data area. The PCA is a test recording area used for determining an optimum intensity value of a recording power of a laser light beam. The data area is used for recording various data. The power calibration area is located on the inner radius side, and includes a test area and a count area as shown in FIG. 6B. The test area includes 100 partitions. Each of these partitions includes 15 frames. A frame is a minimum unit of the recording area on the optical disk.

When performing the OPC, a non-recorded partition in the test area is searched. Test data is recorded on 15 frames of the partition by variously changing an intensity value of a recording power of a laser light beam step by step from a minimum intensity value to a maximum intensity value (i.e., 15 intensity values). The intensity value of the recording power of the laser light beam that provides a highest recording quality is detected by reproducing the recorded test data, and is determined as an optimum intensity value of a recording power of a laser light beam.

The count area includes 100 partitions. Each of these partitions includes 1 frame. The partition in the count area corresponds to the partition in the test area. When the partition in the test area is used, data is recorded in the corresponding partition in the count area and is used for searching a recording start position of the test area.

In a method of calculating a peak power (e.g., the third power intensity P3) from an erase power (e.g., the second power intensity P2), if a signal output from a PD has a high noise and fluctuations, the signal sampled and held by a sample-hold circuit also has a noise and fluctuations. In this condition, the voltage value input to a comparator has various levels. As a result, the second current value IP2 may be set to, for example, three values or four values even though the temperature of the LD does not vary. Further, the third power intensity P3 is determined from the three values or four values of the second power intensity P2. As the third power intensity P3 as a peak power is greater than the second power intensity P2 as an erase power by about two times, fluctuations of the emitted laser light beam of the third power intensity P3 increase two fold. The fluctuations of the peak power directly exert a negative influence on recording quality.

In the OPC according to the embodiment of the present invention, test data is recorded on 15 frames of the partition of the test area by variously changing respective intensity values of the laser light beam of the third power intensity P3 and the laser light beam of the second power intensity P2. The emitted laser light beam of the second power intensity P2 is subjected to the APC in each frame of the partition of the test area and is controlled at a constant level in the APC. In the OPC, a period for recording test data on the test area with respective predetermined intensity values of the laser light beam of the third power intensity P3 and the laser light beam of the second power intensity P2 is very short as compared to a case in which actual information data is recorded on the data area. For example, immediately after the laser light beam of the second power intensity P2 is subjected to the APC and its power intensity value becomes constant in one of 15 frames of a partition of the test area, test data is recorded on another frame of the partition of the test area with respective changed intensity values of the laser light beam of the third power intensity P3 and the laser light beam of the second power intensity P2.

As described above, in the laser controller of the present embodiment, if the second current value IP2 fluctuates, the third current value IP3 fluctuates accordingly. Further, if the second power intensity P2 fluctuates between, for example, three values or four values, the third power intensity P3 also fluctuates between three values or four values. If the above-described OPC is performed in the condition that the laser light beam of the third power intensity P3 and the laser light beam of the second power intensity P2 fluctuate, an optimum intensity value of a recording power of a laser light beam cannot be adequately determined. Further, in this condition, if the OPC is performed in the same optical disk under the same condition (e.g., a recording speed), an optimum intensity value of a recording power determined by the OPC varies. Therefore, in the optical disk apparatus according to the embodiment of the present invention, the light-emitting power of the laser light beam emitted from the LD needs to be prevented from fluctuating to determine an optimum intensity value of a recording power in OPC operations for a CD-RW disk.

In the optical disk apparatus of the embodiment of the present invention, before recording test data on 15 frames of the partition of the test area by variously changing respective intensity values of the laser light beam of the third power intensity P3 and the laser light beam of the second power intensity P2 in the OPC operation, the laser light beam of the second power intensity P2 functioning as a DC erase power is continuously emitted to 15 frames of the partition of the test area at a constant power intensity value. During a period in which the laser light beam of the second power intensity P2 is continuously emitted to the 15 frames of the partition of the test area, a plurality of second current values IP2 supplied to the LD are obtained as sample values. Subsequently, an average second current value of the plurality of obtained second current values IP2 is calculated, and a laser efficiency value EV2, that is, a ratio between a current value and a light-emitting power, is obtained by the following equation,

EV2=(P2−P1)/IP2(av) (3)

where P2 is the second power intensity, P1 is the first power intensity, and IP2(av) is the average second current value.

Further, the third current value IP3 required to be supplied to the LD to emit a laser light beam at a power level of the third power intensity P3 is determined by the following equation,

IP3=(P3−P2)/EV2 (4)

where P3 is the third power intensity, P2 is the second power intensity, and EV2 is the laser efficiency value obtained by the equation (3).

Subsequently, the OPC operation is performed such that test data is recorded on the 15 frames of the partition of the test area to which the laser light beam of the second power intensity P2 is continuously emitted while variously changing respective intensity values of the laser light beam of the third power intensity P3 and the laser light beam of the second power intensity P2. In the equation (4), the respective intensity values of the third power intensity P3 and the second power intensity P2 are changed to 15 intensity values. Each third current value IP3 required to be supplied to the LD to emit a laser light beam at a predetermined power level (one of 15 intensity values) of the third power intensity P3 is determined based on the laser efficiency value EV2 obtained by the equation (3) using the average second current value IP2(av). With this laser power control operation, as compared to a case in which the third current value IP3 is determined based on the laser efficiency value EV1 obtained from the fluctuated second current value IP2, the third current value IP3, which is determined based on the laser efficiency value EV2 obtained from the average second current value IP2(av), is prevented from fluctuating significantly. Therefore, according to the embodiment of the present invention, even if the second current value IP2 fluctuates in the OPC operation, fluctuations of a peak power (i.e., the third power intensity P3) are avoided in the OPC operation. As a result, a recording quality in the OPC operation is enhanced, and thereby an optimum intensity value of a recording power of a laser light beam is adequately determined.

A recording speed is preset in each optical disk. The recording speed of an optical disk was mainly 1 time (1×) speed or 2 times (2×) speed before. Recently, the recording speed of an optical disk is generally in a range of 4 times (4×) speed to 16 times (16×) speed. An intensity value of a recording power of a laser light beam emitted from an LD to an optical disk changes according to a recording speed. This is because each optical disk has an optimum length of a time period in which the laser light beam of the first power intensity P1 is emitted and an optimum length of a time period in which the laser light beam of the third power intensity P3 is emitted in a recording period. An intensity value of a recording power of a laser light beam changes according to these time lengths. For example, when the length of a time period in which the laser light beam of the third power intensity P3 is emitted is relatively long, the average amount of laser light beam emitted to an optical disk increases. Therefore, the intensity value of the recording power is set to be low. When the length of a time period in which the laser light beam of the third power intensity P3 is emitted is relatively short, the average amount of laser light beam emitted to an optical disk decreases. Therefore, the intensity value of the recording power is set to be high.

As described above, in an OPC operation, test data is recorded on 15 frames of a partition of a test area by variously changing an intensity value of a recording power of a laser light beam step by step from a minimum intensity value to a maximum intensity value (i.e., 15 intensity values). The range between the minimum intensity value to the maximum intensity value is changed according to a length of a time period in which the laser light beam of the first power intensity P1 is emitted and a length of a time period in which the laser light beam of the third power intensity P3 is emitted. Further, the middle intensity value of the range between the minimum intensity value to the maximum intensity value is set to an estimated optimum intensity value of the recording power of the laser light beam.

For example, if the intensity value of the recording power is desired to be low and if a laser light beam of a relatively high second power intensity P2 (i.e., a DC erase power) is continuously emitted to 15 frames of a partition of a test area and an average second current value IP2(av) of a plurality of second current values IP2 is calculated before performing an OPC operation, a laser efficiency value EV2 obtained from the average second current value IP2(av) is significantly different from a laser efficiency value EV1 obtained from a second current value IP2 supplied to the LD in actual recording. Further, an optimum intensity value of a recording power of a laser light beam determined based on the laser efficiency value EV2 in the OPC operation is different from an optimum intensity value of a recording power of a laser light beam desired to be set in the actual recording. In this case, a recording quality is degraded in the actual recording.

In order to prevent the above-described problem, a value of the second power intensity P2 (i.e., the DC erase power) of the laser light beam emitted from the LD to the partition of the test area before recording test data into the partition of the test area is changed according to a type of an optical disk. The type of optical disk indicates a characteristic of the optical disk, such as, a sensitivity, a physical property, and a recording speed. By doing so, the laser efficiency value (EV2) obtained from the average second current value IP2(av) is close to the laser efficiency value EV1 obtained from a second current value IP2 supplied to the LD in actual recording, so that a high recording quality is achieved.

Further, a recording speed is different among optical disks. A user selects a recording speed for an optical disk. As described above, an intensity value of a recording power of a laser light beam emitted from an LD to an optical disk changes according to a recording speed. If a recording speed of an optical disk is in a range of 1× speed to 2× speed, a range between a minimum intensity value to a maximum intensity value of a recording power of a laser light beam in an OPC operation does not differ greatly according to the recording speed. On the other hand, if a recording speed of an optical disk is in a range of 4× speed to 16× speed, a range between a minimum intensity value to a maximum intensity value of a recording power of a laser light beam in an OPC operation differs greatly according to the recording speed.

For example, if the intensity value of the recording power is desired to be low and if a laser light beam of a relatively high second power intensity P2 (i.e., a DC erase power) is continuously emitted to 15 frames of a partition of a test area and an average second current value IP2(av) of a plurality of second current values IP2 is calculated before performing an OPC operation, a laser efficiency value EV2 obtained from the average second current value IP2(av) is significantly different from a laser efficiency value EV1 obtained from a second current value IP2 supplied to the LD in actual recording. Further, an optimum intensity value of a recording power of a laser light beam determined based on the laser efficiency value EV2 in the OPC operation is different from an optimum intensity value of a recording power of a laser light beam desired to be set in the actual recording. In this case, a recording quality is degraded in the actual recording.

In order to prevent the above-described problem, a value of the second power intensity P2 (i.e., the DC erase power) of the laser light beam emitted from the LD to the partition of the test area before recording test data into the partition of the test area is changed according to a recording speed when recording the test data into the partition of the test area in the OPC operation. The recording speed in the OPC operation is set to be equal to the recording speed in the actual recording. By doing so, the laser efficiency value EV2 obtained from the average second current value IP2(av) is close to the laser efficiency value EV1 obtained from a second current value IP2 supplied to the LD in actual recording, so that a high recording quality is achieved.

When emitting the laser light beam of the second power intensity P2 (i.e., the DC erase power) to an optical disk, a recording speed does not influence an erase quality, which is different from the case of pulse light-emitting. Therefore, in the case of erasing data in the data area shown in FIG. 6A, the laser light beam of the DC erase power is emitted to the data area at a high erasing speed. However, when emitting the laser light beam of the second power intensity P2 (i.e., the DC erase power) to a partition of a test area before performing an OPC operation at a predetermined erasing speed different from a recording speed in the OPC operation (and actual recording), processes of changing speed and changing rotation number of a spindle motor (described below) that drives an optical disk to rotate are required to be performed. Therefore, in the optical disk apparatus according to the embodiment of the present invention, the erasing speed when emitting the laser light beam of the second power intensity P2 (i.e., the DC erase power) to the partition of the test area before performing the OPC operation is set to be equal to the recording speed in the OPC operation. By doing so, the processes of changing speed and changing rotation number of the spindle motor need not be performed. As a result, a time before the start of the OPC operation can be saved.

In the above-described laser controller as a laser power control device according to the embodiment of the present invention, the CPU 37 controls the operation of each of the above-mentioned parts or mechanisms of the laser controller according to programs stored in a ROM (not shown) in the CPU 37. Further, respective values of the first power intensity P1 and the second power intensity P2 are determined based on the first reference voltage value (Vref1) and the second reference voltage value (Vref2), respectively. A correspondence between the first power intensity P1 and the first reference voltage value (Vref1) and a correspondence between the second power intensity P2 and the second reference voltage value (Vref1) are stored in a form of a parameter table in the ROM in the CPU 37.

Further, as shown in FIG. 2, the circuit of the laser controller is divided into two sections, that is, an auto power control (APC) section 30 and an LD driver section 31. The LD driver section 31 functions as a laser diode drive mechanism that drives the LD by supplying current to the LD. The APC section 30 functions as a power intensity adjusting mechanism that adjusts a power intensity of a laser light beam emitted from the LD based on a light-emitting power of a laser light beam detected by the PD by changing a value of the current supplied to the LD by the LD driver section 31.

In the laser controller, the second current value IP2 is obtained by converting digital data transmitted from the CPU 37 to the second D/A converter 39 to a current value in consideration of the influence of the second V/I converter 42 and the second current amplifier 46.

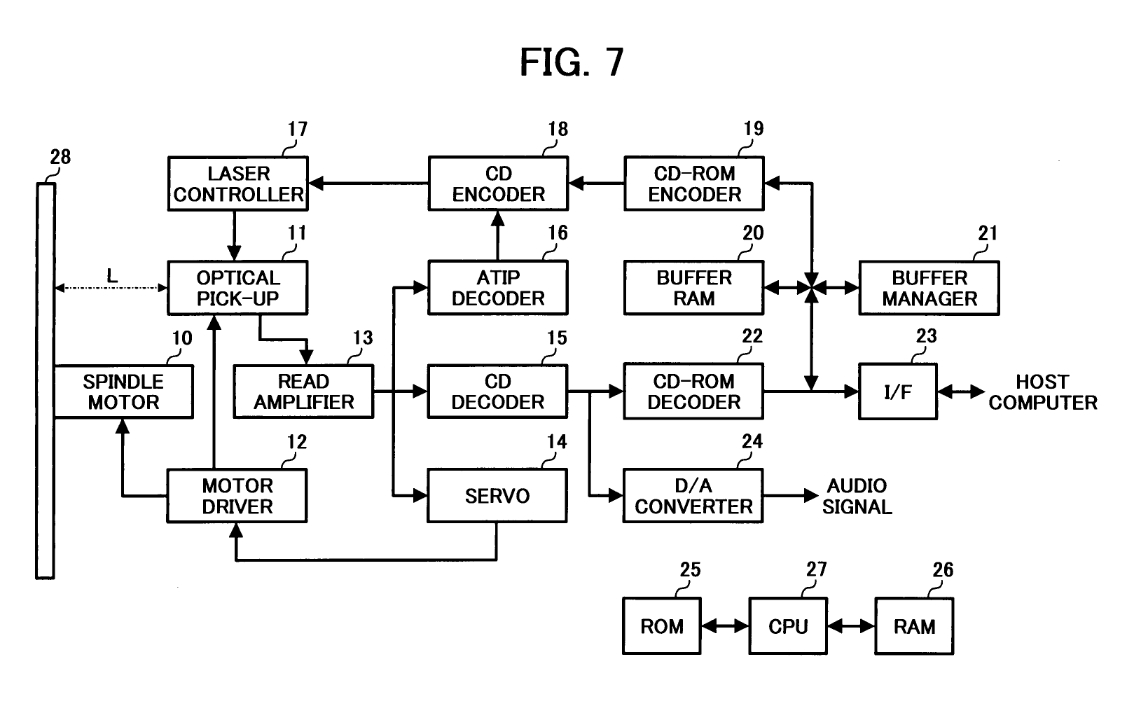

FIG. 7 is a block diagram of a configuration of an optical disk apparatus according to an embodiment of the present invention.

Generally, a CD-R (CD recordable) disk and a CD-E (CD erasable) disk are recordable compact disks. The CD-R disk is referred to as a “CD-Write once” into which information (data) can be recorded only one time. The CD-E disk is referred to as a “CD-RW” (CD rewritable) into which information can be recorded a plurality of times. Information is recorded into and reproduced from an optical disk, such as the above-described CD-R disk and CD-E disk, by the optical disk apparatus shown in FIG. 7.

The optical disk apparatus includes a spindle motor 10, an optical pick-up 11, a motor driver 12, a read amplifier 13, a servo 14, a CD decoder 15, an ATIP decoder 16, a laser controller 17, a CD encoder 18, a CD-ROM encoder 19, a buffer RAM 20, a buffer manager 21, a CD-ROM decoder 22, an interface (I/F) 23 such as an ATAPI/SCSI, a D/A converter 24, a ROM 25, a RAM 26, and a CPU 27. A reference symbol “L” in FIG. 7 indicates a laser light beam. In this embodiment, the laser controller 17 corresponds to a laser controller of FIG. 2. The control signals at the respective switches in the laser controller of FIG. 2, such as, the first sample signal, the second sample signal, the LD ON signal, the first write pulse superimposed signal, and the second write pulse superimposed signal, are output from the CD encoder 18. Further, the laser controller 17 corresponds to a laser power control device of the present invention and performs a method of determining a value of current supplied to a laser power source of the present invention. Further, the optical disk apparatus of FIG. 7 corresponds to an information recording apparatus and an optical disk apparatus of the present invention and performs a method of recording information data into a recording medium and a method of recording information data into an optical recording medium of the present invention.

In FIG. 7, directions indicated by arrows indicate the directions in which data flow mainly. To simplify the diagram, a detail connection relation between the CPU 27 and each block controlled by the CPU 27 is not shown in FIG. 7.

A readable control program for the CPU 27 is stored in the ROM 25. When turning on a power supply of the optical disk apparatus, the control program is loaded into a main memory (not shown). The CPU 27 controls operations in each of the blocks according to the control program, and temporarily stores data necessary for controlling the blocks in the RAM 26.

The optical disk 28 is rotated by the spindle motor 10. The spindle motor 10 is controlled, by the motor driver 12 and the servo 14, such that a light spot on the optical disk 28 has a constant linear velocity. It is possible to change the linear velocity in phase. The optical pick-up 11 includes a semi-conductor laser which corresponds to a laser diode (LD), an optical system, a focus actuator, a track actuator, a photo detector, and a position sensor (all of which are not shown). The optical pick-up 11 emits a laser light beam “L” to the recording surface of the optical disk 28. The optical pick-up 11 is configured to be moved along a sledge direction by a seek motor (not shown). The focus actuator, the track actuator, and the seek motor are controlled to locate a light spot of the laser light beam “L” at a desired position on the optical disk 28 by using the motor driver 12 and the servo 14 based on signals from the photo detector and the position sensor of the optical pick-up 11.

When reproducing data, a reproducing signal obtained from the optical pick-up 11 is amplified by the read amplifier 13 to convert into binary data. The binary data is input to the CD decoder 15, where de-interleave and error correction are carried out. The CD decoder 15 performs an EFM (Eight to Fourteen bit Modulation) to decode the binary data into decoded data. Recorded data in the optical disk 28 are modulated in EFM that is summed up 8 bits at a time. It is converted 8 bits to 14 bits and then to 17 bits by adding 3 coupling bits in an EFM process. In this case, the coupling bits are added to equalize the numbers of “1” and “0” on average as a whole. This process is referred to as “suppression of DC elements”, and suppresses slice level fluctuations in DC cut reproduction signals.

Decoded data is de-interleaved and error-corrected. Subsequently, the data is input to the CD-ROM decoder 22 and subjected to an additional error-correction to improve data reliability. Then, the data is stored in the buffer RAM 20 once by the buffer manager 21. If the stored data gets into sector datum, the sector datum is transferred to a host computer through the interface 23 as a sector datum unit. In the case of audio data, data output from the CD decoder 15 is input to the D/A converter 24 and is output as analog audio output signals.

When recording data, data is transferred from the host computer to the optical disk apparatus through the interface 23 and the data is stored in the buffer RAM 20 once by the buffer manager 21. A writing process is started by storing a certain level of data in the buffer RAM 20. Before writing data on the optical disk 28, the laser spot needs to be put in a write start position. This position is searched with a wobble signal formed on the optical disk 28 as track grooves.

The wobble signal contains information on absolute time referred to as ATIP (Absolute Time In Pre-groove). The information on absolute time is obtained from the ATIP decoder 16. A synchronization signal generated by the ATIP decoder 16 is input to the CD encoder 18, and this signal makes it possible to write data into an accurate position on the optical disk 28. Error-correction codes are added to the data in the buffer RAM 20, and the data is interleaved in the CD-ROM encoder 19 and the CD encoder 18, before data is written in the optical disk 28 through the laser controller 17 and the optical pick-up 11.

The EFM modulated data, as bit streams, drives the laser at a channel bit rate of 4.3218 Mbps (a standard speed). In this case, the recorded data makes up an EFM frame per 588 channel bits unit. A channel clock means a clock in a frequency of the channel bits.

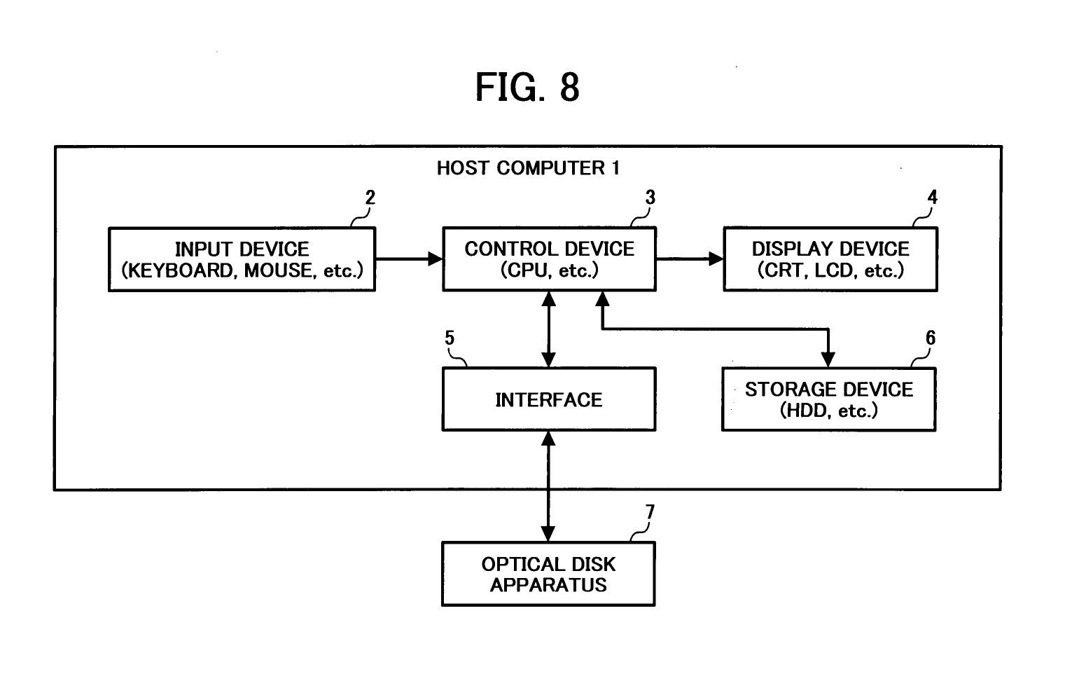

FIG. 8 is a block diagram of a configuration of an information processing system including the above-described optical disk apparatus of FIG. 7. The information processing system includes a host computer 1 and an optical disk apparatus 7 that corresponds to the optical disk apparatus of FIG. 7. The host computer 1 includes an input device 2, a control device 3, a display device 4, an interface 5, and a storage device 6. The control device 3 includes a microcomputer including a CPU, a ROM, and a RAM, and controls the entire information processing system.

The interface 5 is a two-way transmission interface with the optical disk apparatus 7. The interface may comply with interface standards, such as ATAPI and SCSI. This interface 5 is connected with an interface (not shown) of the optical disk apparatus 7. The connection between each interface may be a cable connection using a communication line such as a communication cable (e.g. SCSI cable), or it may be a wireless connection using infrared data communication, etc.

A program described as a readable code with the microcomputer in the control device 3 is stored in the storage device 6. The storage device 6 may include a hard disk (HDD), etc. When turning on the power in the host computer 1, this program is loaded into a main memory in the control device 3 from the storage device 6.

The display device 4 may include a Cathode-Ray Tube (CRT), a Liquid Crystal Display (LCD) and a Plasma Display Panel (PDP), etc. The display device 4 displays various types of information from the control device 3.

The input device 2 may be at least one of various input media, such as a keyboard, a mouse, and/or a pointing device, etc. The input device 2 notifies the control device 3 of various types of information input by a user. Information from the input media also may be input through a wireless system. Further, a CRT with a touch panel, etc. may be used to unify the input device 2 and the display device 4.

The host computer 1 supports an operating system. All devices in the host computer 1 are managed by the operating system.

Next, a CD-R drive apparatus that records and reproduces information into and from a CD-R (CD-Recordable) disk as a write-once media will be described.

An optical disk, such as a compact disk is formed in general with at least a recording surface provided thereon with tracks (or pregrooves) formed continuously in the shape of a spiral or concentric circles. Tracks are formed on a recording surface of an optical disk at a pitch of 1.6 micron in the direction of a disk radius.

In addition, two regions are formed on the recording surface of the optical disk, respectively referred to as mark (pit) and space regions each having light reflectivity different from the other, such that information is recorded by the combination of these two regions each having suitable length and arrangement on the recording surface.

A CD-R drive apparatus is configured in general to perform record or erase of information data by a laser light beam spot incident onto a surface of a CD-R disk, and data readout by a laser light beam reflected back from the surface of the CD-R disk. The CD-R drive apparatus may have the same configuration as that of the optical disk apparatus shown in FIG. 7.

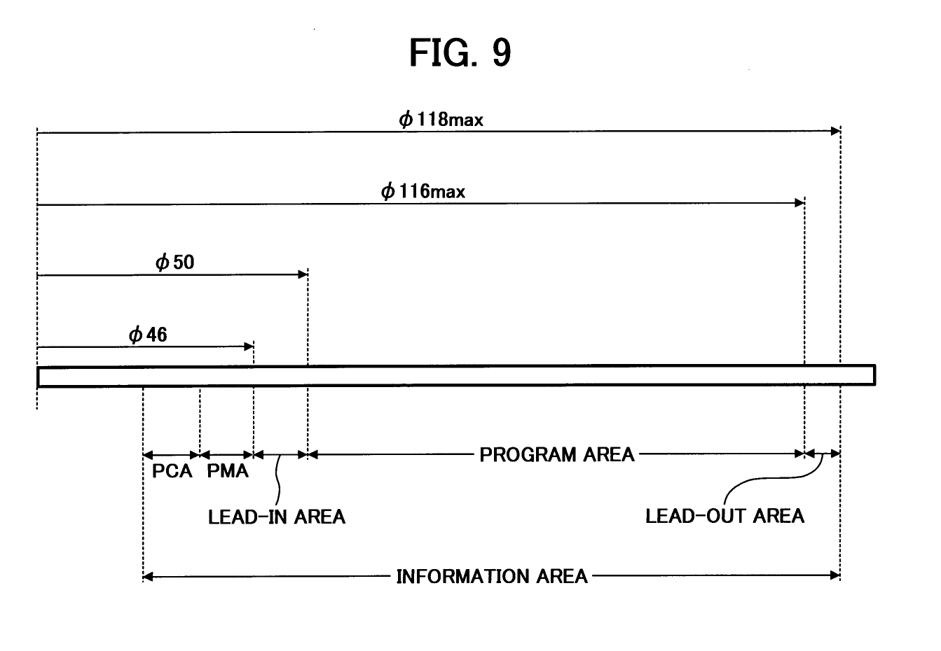

FIG. 9 is a diagram showing a structure of a recording area of an optical disk. FIG. 9 shows a cross section taken along a radial direction of the optical disk. An information area of the optical disk includes, from the inner periphery towards the outer periphery of the optical disk, a power calibration area (PCA), a program memory area (PMA), a lead-in area, a program area, and a lead-out area.

In the case of a CD-ROM disk, a lead-in area is arranged in a radial area ranging from 46 mm to 50 mm from the inner periphery towards the outer periphery of the disk. Marks (pits) are not formed in a radial area within 46 mm, that is, an innermost portion of the disk. In the case of a CD-R disk and a CD-RW disk, the PCA and the PMA are provided in the radial area within 46 mm at the inner side of the lead-in area. In the PCA, the above-described OPC operation is performed.

Information data is recorded into an optical disk, in recording units called sessions. Each session is separated into three areas, i.e., the lead-in area, the program area, and the lead-out area. In the program area, information which a user actually records or reproduces is recorded in recording units called tracks.

In the PMA, a start address and an end address of a track in which information is recorded in the program area is stored. In the case of an audio CD, a single track is used for a single song, and songs can be recorded in 99 tracks, respectively. The information of each track is finally recorded in the lead-in area as a table of contents of tracks (TOC). In the case of a CD-R disk, the information of each track is not fixed until an appending operation is completed. Therefore, until the TOC is recorded in the lead-in area, the information of each track is recorded in the PMA.

After the TOC is recorded in the lead-in area and information is recorded in the lead-out area, the information recorded into an optical disk can be reproduced. This condition is called a closed session. If a recordable area exists at a position outside of a closed session, information can be appended in another session including the lead-in area, the program area, and the lead-out area. A plurality of sessions on an optical disk is referred to as multi sessions.

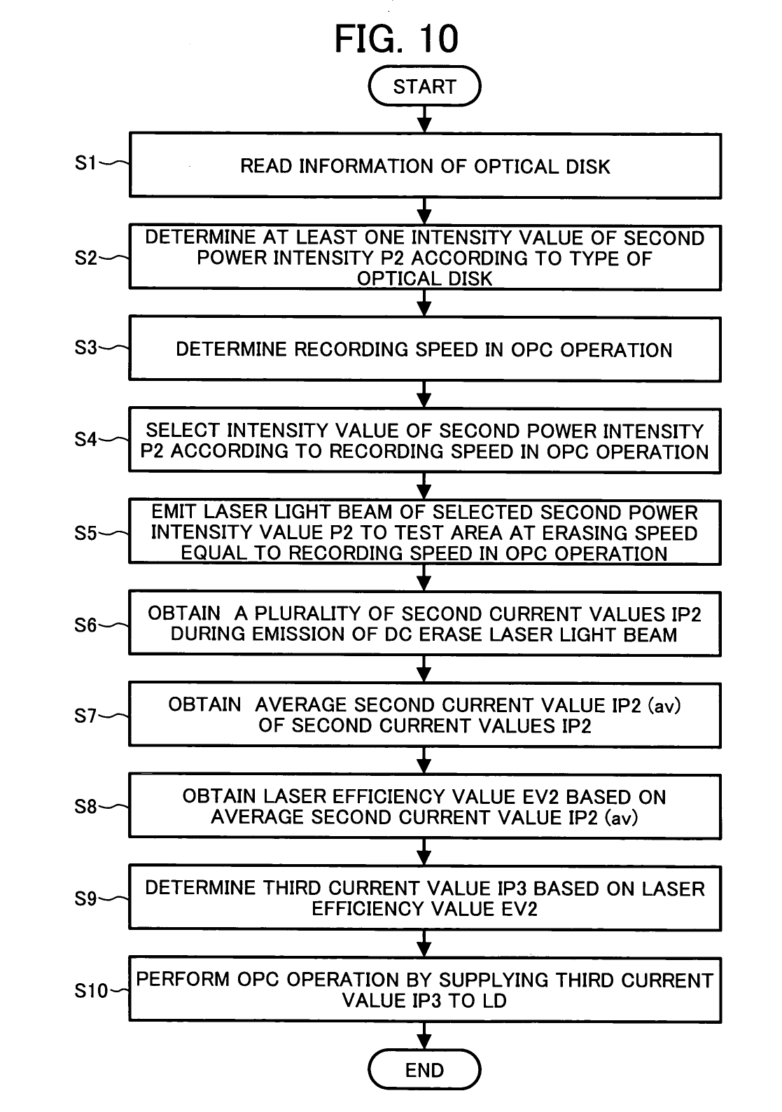

Next, laser power control operation steps of the CPU 37 in the optical disk apparatus will be described referring to FIG. 10. FIG. 10 is a flowchart of laser power control operation steps of the CPU 37 according to the embodiment of the present invention. First, the CPU 37 reads information of an optical disk to determine a type of the optical disk in step S1. Then, the CPU 37 determines an intensity value of the second power intensity P2 (i.e., the DC erase power) of the laser light beam emitted from the LD to a partition of a test area before recording test data into the partition of the test area (i.e., before performing an OPC operation) according to the type of the optical disk in step S2. As described above, a recording speed is preset in each optical disk. If a recording speed of an optical disk is 1× speed or 2× speed (i.e., a low-recording speed type optical disk), the CPU 37 determines one intensity value of the second power intensity P2 (i.e., the DC erase power) of the laser light beam in step S2. If a recording speed of an optical disk is in a range of 4× speed to 16× speed (i.e., a high-recording speed type optical disk), the CPU 37 determines at least two intensity values of the second power intensity P2 (i.e., the DC erase power) of the laser light beam in step S2. Then, the CPU 37 determines a recording speed in an OPC operation (i.e., a speed of recording test data into a partition of a test area) in step S3. If the CPU 37 determines one intensity value of the second power intensity P2 (i.e., the DC erase power) for a low-recording speed type optical disk, the CPU 37 does not need to change the intensity value of the second power intensity P2 according to the recording speed in the OPC operation determined in step S3. However, if a user selects a low-recording speed for a high-recording speed type optical disk, that is, if a user selects 4× recording speed for an optical disk whose recording speed is in a range of 4× speed to 16× speed, the CPU 37 selects one of the at least two intensity values of the second power intensity P2 determined in step S2 according to the recording speed in the OPC operation in step S4.

Next, in step S5, the CPU 37 causes the LD to emit a laser light beam of the selected second power intensity value P2 (i.e., the selected DC erase power value) continuously to a partition of a test area at an erasing speed equal to the recording speed in the OPC operation determined in step S3. Subsequently, during a period in which the laser light beam of the selected second power intensity value P2 is continuously emitted to the partition of the test area (i.e., during emission of a DC erase laser light beam), the CPU 37 obtains a plurality of second current values IP2 supplied to the LD as sample values in step S6. The period, in which the laser light beam of the selected second power intensity value P2 is continuously emitted to the partition of the test area, is preferably long to increase the number of the sample second current values IP2. However, if the laser light beam of the selected second power intensity value P2 is continuously emitted to a part of a test area longer than a partition of the test area in which the OPC operation is performed, and if the above-described part of the test area includes a last partition of the test area that is adjacent to a count area, a part of the count area is erased by the DC erase power. As a result, a recording start position of the test area for performing an OPC operation cannot be adequately searched. Therefore, it is preferable that the laser light beam of the selected second power intensity value P2 is continuously emitted to a part of a test area somewhat shorter than a partition of the test area in which the OPC operation is performed. Further, if the number of the second current values IP2 as sample values is relatively great, the capacity of a memory for storing the second current values IP2 needs to be increased. For these reasons, the number of the second current values IP2 as sample values is preset according to each size of a partition of a test area and a memory.

Next, in step S7, the CPU 37 obtains an average current value of the plurality of the second current values IP2 obtained in step S6. Further, the CPU 37 obtains a laser efficiency value EV2, that is, a ratio between a current value and a light-emitting power, by the equation (3) in step S8,

EV2=(P2−P1)/IP2(av) (3)

where P2 is the second power intensity, P1 is the first power intensity, and IP2(av) is the average second current value.

Further, the CPU 37 determines the third current value IP3 required to be supplied to the LD to emit a laser light beam at a power level of the third power intensity P3 by the equation (4) in step S9,

IP3=(P3−P2)/EV2 (4)

where P3 is the third power intensity, P2 is the second power intensity, and EV2 is the laser efficiency value obtained by the equation (3).

Then, the CPU 37 performs an OPC operation by supplying the third current value IP3 determined by the equation (4) to the LD in step S10.

With the above-described laser power control operation, as compared to a case in which the third current value IP3 is determined based on the laser efficiency value EV1 obtained from the fluctuated second current value IP2 (see the equations (1) and (2)), the third current value IP3, which is determined based on the laser efficiency value EV2 obtained from the average second current value IP2(av), is prevented from fluctuating significantly in the OPC operation. Therefore, in the optical disk apparatus according to the embodiment of the present invention, even if the second current value IP2 fluctuates in the OPC operation, fluctuations of a peak power (i.e., the third power intensity P3) are avoided in the OPC operation of the present embodiment. As a result, a recording quality in the OPC operation is enhanced, and thereby an optimum intensity value of a recording power of a laser light beam is adequately determined.

The above-described laser controller and a laser power control operation may be applied to an optical magnetic disk apparatus that records and reproduces information on/from an optical magnetic disk, such as a magneto-optical (MO) disk and a mini disk (MD) by use of a laser power.

The present invention has been described with respect to the exemplary embodiments illustrated in the figures. However, the present invention is not limited to these embodiments and may be practiced otherwise.

Numerous additional modifications and variations of the present invention are possible in light of the above teachings. It is therefore understood that within the scope of the appended claims, the present invention may be practiced other than as specifically described herein.

What is claimed as new and desired to be protected by Letters Patent of the United States is:

1. A laser power control device that controls a light-emitting power of a laser light beam emitted from a laser power source that emits at least a laser light beam of first power intensity, a laser light beam of second power intensity greater than the first power intensity, and a laser light beam of third power intensity greater than the second power intensity to record information data into a recording medium, the laser power control device comprising:
a characteristic obtaining mechanism configured to obtain a characteristic of the laser power source by causing the laser power source to emit the laser light beam of the second power intensity before recording information data into the recording medium; and
a current value determining mechanism configured to determine a value of current required to be supplied to the laser power source to emit the laser light beam of the third power intensity from the laser power source based on the characteristic of the laser power source obtained by the characteristic obtaining mechanism.

2. The laser power control device according to claim 1, wherein the characteristic obtaining mechanism is configured to cause the laser power source to emit the laser light beam of the second power intensity continuously during a predetermined period.

3. The laser power control device according to claim 1,
wherein the characteristic obtaining mechanism comprises a current value obtaining mechanism configured to obtain a plurality of values of current supplied to the laser power source during a period in which the characteristic obtaining mechanism causes the laser power source to emit the laser light beam of the second power intensity, and configured to obtain an average current value of the plurality of values of current, and the characteristic obtaining mechanism is configured to obtain the characteristic of the laser power source based on the average current value obtained by the current value obtaining mechanism.

4. The laser power control device according to claim 1, wherein the characteristic obtaining mechanism is configured to cause the laser power source to emit the laser light beam of the second power intensity to a light-emitting power calibration area provided in the recording medium to be used for determining an optimum recording condition for recording information data into the recording medium.

5. The laser power control device according to claim 3,
wherein a first value of current is supplied to the laser power source to emit the laser light beam of the first power intensity from the laser power source, the first value of current and a second value of current are supplied to the laser power source to emit the laser light beam of the second power intensity from the laser power source, and the first value of current, the second value of current, and a third value of current are supplied to the laser power source to emit the laser light beam of the third power intensity from the laser power source,
wherein the current value obtaining mechanism is configured to obtain a plurality of the second values of current supplied to the laser power source during the period in which the characteristic obtaining mechanism causes the laser power source to emit the laser light beam of the second power intensity, and is configured to obtain an average current value of the plurality of the second values of current,
wherein the characteristic of the laser power source obtained by the characteristic obtaining mechanism includes a laser efficiency value (EV) obtained by a following equation,
EV=(P2−P1)/IP2(av)
where P2 is the second power intensity, P1 is the first power intensity, and IP2(av) is the average current value of the plurality of the second values of current obtained by the current value obtaining mechanism, and
wherein the current value determining mechanism is configured to determine the third value of current (IP3) required to be supplied to the laser power source to emit the laser light beam of the third power intensity from the laser power source by a following equation,
IP3=(P3−P2)/EV
where P3 is the third power intensity, P2 is the second power intensity, and EV is the laser efficiency value.

6. An information recording apparatus that records information data into a recording medium by emitting a laser light beam to the recording medium, the information recording apparatus comprising:
a laser power source configured to emit at least a laser light beam of first power intensity, a laser light beam of second power intensity greater than the first power intensity, and a laser light beam of third power intensity greater than the second power intensity to the recording medium; and
a laser power control device that controls a light-emitting power of a laser light beam emitted from the laser power source, the laser power control device comprising,
a characteristic obtaining mechanism configured to obtain a characteristic of the laser power source by causing the laser power source to emit the laser light beam of the second power intensity before recording information data into the recording medium; and
a current value determining mechanism configured to determine a value of current required to be supplied to the laser power source to emit the laser light beam of the third power intensity from the laser power source based on the characteristic of the laser power source obtained by the characteristic obtaining mechanism.

7. The information recording apparatus according to claim 6, wherein the characteristic obtaining mechanism is configured to cause the laser power source to emit the laser light beam of the second power intensity continuously during a predetermined period.

8. The information recording apparatus according to claim 6, wherein the characteristic obtaining mechanism comprises a current value obtaining mechanism configured to obtain a plurality of values of current supplied to the laser power source during a period in which the characteristic obtaining mechanism causes the laser power source to emit the laser light beam of the second power intensity, and configured to obtain an average current value of the plurality of values of current, and the characteristic obtaining mechanism is configured to obtain the characteristic of the laser power source based on the average current value obtained by the current value obtaining mechanism.

9. The information recording apparatus according to claim 6, wherein the characteristic obtaining mechanism is configured to cause the laser power source to emit the laser light beam of the second power intensity to a light-emitting power calibration area provided in the recording medium to be used for determining an optimum recording condition for recording information data into the recording medium.

10. The information recording apparatus according to claim 8, wherein a first value of current is supplied to the laser power source to emit the laser light beam of the first power intensity from the laser power source, the first value of current and a second value of current are supplied to the laser power source to emit the laser light beam of the second power intensity from the laser power source, and the first value of current, the second value of current, and a third value of current are supplied to the laser power source to emit the laser light beam of the third power intensity from the laser power source,
wherein the current value obtaining mechanism is configured to obtain a plurality of the second values of current supplied to the laser power source during the period in which the characteristic obtaining mechanism causes the laser power source to emit the laser light beam of the second power intensity, and is configured to obtain an average current value of the plurality of the second values of current,
wherein the characteristic of the laser power source obtained by the characteristic obtaining mechanism includes a laser efficiency value (EV) obtained by a following equation,
EV=(P2−P1)/IP2(av)
where P2 is the second power intensity, P1 is the first power intensity, and IP2(av) is the average current value of the plurality of the second values of current obtained by the current value obtaining mechanism, and
wherein the current value determining mechanism is configured to determine the third value of current (IP3) required to be supplied to the laser power source to emit the laser light beam of the third power intensity from the laser power source by a following equation,
IP3=(P3−P2)/EV
where P3 is the third power intensity, P2 is the second power intensity, and EV is the laser efficiency value.

11. The information recording apparatus according to claim 9, further comprising an optimum recording power intensity value determining mechanism configured to determine an optimum recording power intensity value of the laser light beam emitted from the laser power source by recording test data on the light-emitting power calibration area and by reproducing the test data, the optimum recording power intensity value determining mechanism being configured to record the test data on the light-emitting power calibration area with a plurality of laser light beams each having a different power intensity that is emitted from the laser power source based on the value of current determined by the current value determining mechanism.

12. The information recording apparatus according to claim 11, wherein the optimum recording power intensity value determining mechanism is configured to record the test data on the light-emitting power calibration area with at least the laser light beam of the third power intensity by variously changing the value of the third power intensity which corresponds to the value of current determined by the current value determining mechanism.

13. An optical disk apparatus, comprising:
a laser diode configured to emit a digitally modulated laser light beam to an optical recording medium including a light-emitting power calibration area that is used for determining an optimum recording power intensity value of the laser light beam emitted from the laser diode and that includes a test area including a plurality of partitions into which test data is recorded and includes a count area including a plurality of partitions corresponding to the partitions of the test area, the laser light beam emitted from the laser diode including a laser light beam of first power intensity, a laser light beam of second power intensity greater than the first power intensity, and a laser light beam of third power intensity greater than the second power intensity;
a laser diode drive mechanism configured to drive the laser diode by supplying current to the laser diode;
a light-emitting power detecting mechanism configured to detect a light-emitting power of the laser light beam emitted from the laser diode;
a power intensity adjusting mechanism configured to adjust a power intensity of the laser light beam emitted from the laser diode based on the light-emitting power detected by the light-emitting power detecting mechanism by changing a value of the current supplied to the laser diode by the laser diode drive mechanism;
an optimum recording power intensity value determining mechanism configured to determine the optimum recording power intensity value of the laser light beam emitted from the laser diode by recording the test data into one of the partitions of the test area while changing the light-emitting power of the laser light beam emitted from the laser diode, and by reproducing the test data; and
a characteristic obtaining mechanism configured to obtain a characteristic of the laser diode by causing the laser diode to emit the laser light beam of the second power intensity to the one of the partitions of the test area before recording the test data into the one of the partitions,
wherein the light-emitting power of the laser light beam emitted from the laser diode when recording the test data into the one of the partitions of the test area is obtained based on the characteristic of the laser diode obtained by the characteristic obtaining mechanism.

14. The optical disk apparatus according to claim 13,
wherein the optimum recording power intensity value determining mechanism is configured to determine the optimum recording power intensity value of the laser light beam emitted from the laser diode by recording the test data into the one of the partitions of the test area with at least the laser light beam of the third power intensity emitted from the laser diode while variously changing the value of the third power intensity, and
wherein a value of current required to be supplied to the laser diode by the laser diode drive mechanism to emit the laser light beam of the third power intensity when recording the test data into the one of the partitions of the test area for determining the optimum recording power intensity value is determined based on the characteristic of the laser diode obtained by the characteristic obtaining mechanism.

15. The optical disk apparatus according to claim 14, further comprising a current value determining mechanism configured to determine a value of current required to be supplied to the laser diode to emit the laser light beam of the third power intensity from the laser diode based on the characteristic of the laser diode obtained by the characteristic obtaining mechanism,
wherein the characteristic obtaining mechanism comprises a current value obtaining mechanism configured to obtain a plurality of values of current supplied to the laser diode during a period in which the characteristic obtaining mechanism causes the laser diode to emit the laser light beam of the second power intensity, and configured to obtain an average current value of the plurality of values of current, and the characteristic obtaining mechanism is configured to obtain the characteristic of the laser diode based on the average current value obtained by the current value obtaining mechanism,
wherein a first value of current is supplied to the laser diode to emit the laser light beam of the first power intensity from the laser diode, the first value of current and a second value of current are supplied to the laser diode to emit the laser light beam of the second power intensity from the laser diode, and the first value of current, the second value of current, and a third value of current are supplied to the laser diode to emit the laser light beam of the third power intensity from the laser diode,
wherein the current value obtaining mechanism is configured to obtain a plurality of the second values of current supplied to the laser diode during a period in which the characteristic obtaining mechanism causes the laser diode to emit the laser light beam of the second power intensity, and is configured to obtain an average current value of the plurality of the second values of current,
wherein the characteristic of the laser diode obtained by the characteristic obtaining mechanism includes a laser efficiency value (EV) obtained by a following equation,
EV=(P2−P1)/IP2(av)
where P2 is the second power intensity, P1 is the first power intensity, and IP2(av) is the average current value of the plurality of the second values of current obtained by the current value obtaining mechanism, and
wherein the current value determining mechanism is configured to determine the third value of current (IP3) required to be supplied to the laser diode to emit the laser light beam of the third power intensity from the laser diode by a following equation,
IP3=(P3−P2)/EV
where P3 is the third power intensity, P2 is the second power intensity, and EV is the laser efficiency value.

16. The optical disk apparatus according to claim 13, wherein the second power intensity of the laser light beam functions as a DC erase power, and the DC erase power of the laser light beam emitted from the laser diode to the one of the partitions of the test area before recording the test data into the one of the partitions is changed according to a type of the optical recording medium.

17. The optical disk apparatus according to claim 13, wherein the second power intensity of the laser light beam functions as a DC erase power, and the DC erase power of the laser light beam emitted from the laser diode to the one of the partitions of the test area before recording the test data into the one of the partitions is changed according to a recording speed when the optimum recording power intensity value determining mechanism records the test data into one of the partitions of the test area.

18. The optical disk apparatus according to claim 13, wherein the second power intensity of the laser light beam functions as a DC erase power, and the characteristic obtaining mechanism causes the laser diode to emit the laser light beam of the DC erase power to the one of the partitions of the test area at a predetermined erasing speed before recording the test data into the one of the partitions, and wherein the erasing speed is set to be equal to a speed of recording the test data into the one of the partitions.

19. A method of determining a value of current supplied to a laser power source that emits at least a laser light beam of first power intensity, a laser light beam of second power intensity greater than the first power intensity, and a laser light beam of third power intensity greater than the second power intensity to record information data into a recording medium, the method comprising steps of:
obtaining a characteristic of the laser power source by causing the laser power source to emit the laser light beam of the second power intensity before recording information data into the recording medium; and
determining a value of current required to be supplied to the laser power source to emit the laser light beam of the third power intensity from the laser power source based on the characteristic of the laser power source.

20. The method according to claim 19, wherein the obtaining step comprises causing the laser power source to emit the laser light beam of the second power intensity continuously during a predetermined period.

21. The method according to claim 19, wherein the obtaining step comprises,
obtaining a plurality of values of current supplied to the laser power source during a period in which the laser power source emits the laser light beam of the second power intensity;
obtaining an average current value of the plurality of values of current, and
wherein the characteristic of the laser power source is obtained based on the average current value.

22. The method according to claim 19, wherein the obtaining step comprises
causing the laser power source to emit the laser light beam of the second power intensity to a light-emitting power calibration area provided in the recording medium to be used for determining an optimum recording condition for recording information data into the recording medium.

23. The method according to claim 19,
wherein a first value of current is supplied to the laser power source to emit the laser light beam of the first power intensity from the laser power source, the first value of current and a second value of current are supplied to the laser power source to emit the laser light beam of the second power intensity from the laser power source, and the first value of current, the second value of current, and a third value of current are supplied to the laser power source to emit the laser light beam of the third power intensity from the laser power source,
wherein the obtaining step comprises,
obtaining a plurality of the second values of current supplied to the laser power source during a period in which the laser power source is caused to emit the laser light beam of the second power intensity, and
obtaining an average current value of the plurality of the second values of current,
wherein the characteristic of the laser power source includes a laser efficiency value (EV) obtained by a following equation,
EV=(P2−P1)/IP2(av)
where P2 is the second power intensity, P1 is the first power intensity, and IP2(av) is the average current value of the plurality of the second values of current, and
wherein the third value of current (IP3) required to be supplied to the laser power source to emit the laser light beam of the third power intensity from the laser power source is determined by a following equation,
IP3=(P3−P2)/EV
where P3 is the third power intensity, P2 is the second power intensity, and EV is the laser efficiency value.

24. A method of recording information data into a recording medium by emitting a laser light beam to the recording medium from a laser power source that emits at least a laser light beam of first power intensity, a laser light beam of second power intensity greater than the first power intensity, and a laser light beam of third power intensity greater than the second power intensity, the method comprising steps of:
obtaining a characteristic of the laser power source by causing the laser power source to emit the laser light beam of the second power intensity before recording information data into the recording medium;
determining a value of current required to be supplied to the laser power source to emit the laser light beam of the third power intensity from the laser power source based on the characteristic of the laser power source; and
emitting the laser light beam to the recording medium from the laser power source while supplying the current of the determined value to the laser power source.

25. The method according to claim 24, wherein the obtaining step comprises causing the laser power source to emit the laser light beam of the second power intensity continuously during a predetermined period.

26. The method according to claim 24, wherein the obtaining step comprises,
obtaining a plurality of values of current supplied to the laser power source during a period in which the laser power source emits the laser light beam of the second power intensity; and
obtaining an average current value of the plurality of values of current, and
wherein the characteristic of the laser power source is obtained based on the average current value.

27. The method according to claim 24, wherein the obtaining step comprises
causing the laser power source to emit the laser light beam of the second power intensity to a light-emitting power calibration area provided in the recording medium to be used for determining an optimum recording condition for recording information data into the recording medium.

28. The method according to claim 24,
wherein a first value of current is supplied to the laser power source to emit the laser light beam of the first power intensity from the laser power source, the first value of current and a second value of current are supplied to the laser power source to emit the laser light beam of the second power intensity from the laser power source, and the first value of current, the second value of current, and a third value of current are supplied to the laser power source to emit the laser light beam of the third power intensity from the laser power source,
wherein the obtaining step comprises,
obtaining a plurality of the second values of current supplied to the laser power source during a period in which the laser power source is caused to emit the laser light beam of the second power intensity, and
obtaining an average current value of the plurality of the second values of current,
wherein the characteristic of the laser power source includes a laser efficiency value (EV) obtained by a following equation,
EV=(P2−P1)/IP2(av)
where P2 is the second power intensity, P1 is the first power intensity, and IP2(av) is the average current value of the plurality of the second values of current, and
wherein the third value of current (IP3) required to be supplied to the laser power source to emit the laser light beam of the third power intensity from the laser power source is determined by a following equation,
IP3=(P3−P2)/EV
where P3 is the third power intensity, P2 is the second power intensity, and EV is the laser efficiency value.

29. The method of according to claim 27, further comprising,
determining an optimum recording power intensity value of the laser light beam emitted from the laser power source by recording test data on the light-emitting power calibration area and by reproducing the test data,
wherein the test data is recorded on the light-emitting power calibration area with a plurality of laser light beams each having a different power intensity that is emitted from the laser power source based on the determined value of current.

30. The method of according to claim 29, wherein the test data is recorded on the light-emitting power calibration area with at least the laser light beam of the third power intensity by variously changing the value of the third power intensity which corresponds to the determined value of current.

31. A method of recording information data into an optical recording medium by emitting a digitally modulated laser light beam to the optical recording medium from a laser diode that emits at least a laser light beam of first power intensity, a laser light beam of second power intensity greater than the first power intensity, and a laser light beam of third power intensity greater than the second power intensity, the method comprising steps of:
obtaining a characteristic of the laser diode by causing the laser diode to emit the laser light beam of the second power intensity to one of partitions of a test area of the optical recording medium;
determining an optimum recording power intensity value of a laser light beam emitted from the laser diode by recording a test data into the one of partitions of the test area while changing a light-emitting power of the laser light beam emitted from the laser diode, and by reproducing the test data, the light-emitting power of the laser light beam emitted from the laser diode when recording the test data into the one of the partitions of the test area being obtained based on the characteristic of the laser diode;
diving the laser diode by supplying current to the laser diode;
detecting a light-emitting power of the laser light beam emitted from the laser diode; and
adjusting a power intensity of the laser light beam emitted from the laser diode based on the detected light-emitting power by changing a value of the current supplied to the laser diode.

32. The method of according to claim 31,
wherein the determining step comprises determining the optimum recording power intensity value of the laser light beam emitted from the laser diode by recording the test data into the one of the partitions of the test area with at least the laser light beam of the third power intensity emitted from the laser diode while variously changing the value of the third power intensity, and
wherein a value of current required to be supplied to the laser diode to emit the laser light beam of the third power intensity when recording the test data into the one of the partitions of the test area for determining the optimum recording power intensity value is determined based on the characteristic of the laser diode.

33. The method of according to claim 32,
wherein a first value of current is supplied to the laser power source to emit the laser light beam of the first power intensity from the laser power source, the first value of current and a second value of current are supplied to the laser power source to emit the laser light beam of the second power intensity from the laser power source, and the first value of current, the second value of current, and a third value of current are supplied to the laser power source to emit the laser light beam of the third power intensity from the laser power source,
wherein the obtaining step comprises,
obtaining a plurality of the second values of current supplied to the laser power source during a period in which the laser power source is caused to emit the laser light beam of the second power intensity, and
obtaining an average current value of the plurality of the second values of current,
wherein the characteristic of the laser power source includes a laser efficiency value (EV) obtained by a following equation,
EV=(P2−P1)/IP2(av)
where P2 is the second power intensity, P1 is the first power intensity, and IP2(av) is the average current value of the plurality of the second values of current, and
wherein the third value of current (IP3) required to be supplied to the laser power source to emit the laser light beam of the third power intensity from the laser power source is determined by a following equation,
IP3=(P3−P2)/EV
where P3 is the third power intensity, P2 is the second power intensity, and EV is the laser efficiency value.

34. The method of according to claim 31, wherein the second power intensity of the laser light beam functions as a DC erase power, and the DC erase power of the laser light beam emitted from the laser diode to the one of the partitions of the test area before recording the test data into the one of the partitions is changed according to a type of the optical recording medium.

35. The method of according to claim 31, wherein the second power intensity of the laser light beam functions as a DC erase power, and the DC erase power of the laser light beam emitted from the laser diode to the one of the partitions of the test area before recording the test data into the one of the partitions is changed according to a recording speed when recording the test data into one of the partitions of the test area.

36. The method of according to claim 31, wherein the second power intensity of the laser light beam functions as a DC erase power, and the laser light beam of the DC erase power is emitted from the laser diode to the one of the partitions of the test area at a predetermined erasing speed before recording the test data into the one of the partitions, and wherein the erasing speed is set to be equal to a speed of recording the test data into the one of the partitions.

37. A method of controlling a laser power of a laser light beam emitted in an optimum power control operation from a laser power source that emits at least a laser light beam of first power intensity, a laser light beam of second power intensity greater than the first power intensity, and a laser light beam of third power intensity greater than the second power intensity in an optical disk apparatus in which a first value of current is supplied to the laser power source to emit the laser light beam of the first power intensity from the laser power source, the first value of current and a second value of current are supplied to the laser power source to emit the laser light beam of the second power intensity from the laser power source, and the first value of current, the second value of current, and a third value of current are supplied to the laser power source to emit the laser light beam of the third power intensity from the laser power source, the method comprising steps of:
reading information of an optical recording medium;
determining at least one intensity value of the second power intensity according to the information of the optical recording medium;
determining a recording speed in an optimum power control operation (OPC);
selecting one of the at least one intensity value of the second power intensity according to the recording speed in the optimum power control operation;
emitting a laser light beam of a selected second power intensity value continuously to a partition of a test area of the optical recording medium at an erasing speed equal to the determined recording speed in the OPC operation;
obtaining a plurality of second current values supplied to the laser power source as sample values during a period in which the laser light beam of the selected second power intensity value is continuously emitted to the partition of the test area of the optical recording medium;
obtaining an average current value of the plurality of the second current values;
obtaining a laser efficiency value EV2 by a following equation,
EV2=(P2−P1)/IP2(av)
where P2 is the second power intensity, P1 is the first power intensity, and IP2(av) is an average second current value,
determining a third current value IP3 required to be supplied to the laser power source to emit a laser light beam at a power level of the third power intensity by a following equation,
IP3=(P3−P2)/EV2
where P3 is the third power intensity, P2 is the second power intensity, and EV2 is the laser efficiency value, and
performing the optimum power control operation by supplying the third current value IP3 to the laser power source.

38. A laser power control device that controls a light-emitting power of a laser light beam emitted from a laser power source that emits at least a laser light beam of first power intensity, a laser light beam of second power intensity greater than the first power intensity, and a laser light beam of third power intensity greater than the second power intensity to record information data into a recording medium, the laser power control device comprising:
characteristic obtaining means for obtaining a characteristic of the laser power source by causing the laser power source to emit the laser light beam of the second power intensity before recording information data into the recording medium; and
current value determining means for determining a value of current required to be supplied to the laser power source to emit the laser light beam of the third power intensity from the laser power source based on the characteristic of the laser power source obtained by the characteristic obtaining means.

39. The laser power control device according to claim 38, wherein the characteristic obtaining means causes the laser power source to emit the laser light beam of the second power intensity continuously during a predetermined period.

40. The laser power control device according to claim 38,
wherein the characteristic obtaining means comprises current value obtaining means for obtaining a plurality of values of current supplied to the laser power source during a period in which the characteristic obtaining means causes the laser power source to emit the laser light beam of the second power intensity, and for obtaining an average current value of the plurality of values of current, and the characteristic obtaining means obtains the characteristic of the laser power source based on the average current value obtained by the current value obtaining means.

41. The laser power control device according to claim 38, wherein the characteristic obtaining means causes the laser power source to emit the laser light beam of the second power intensity to a light-emitting power calibration area provided in the recording medium to be used for determining an optimum recording condition for recording information data into the recording medium.

42. The laser power control device according to claim 40,
wherein a first value of current is supplied to the laser power source to emit the laser light beam of the first power intensity from the laser power source, the first value of current and a second value of current are supplied to the laser power source to emit the laser light beam of the second power intensity from the laser power source, and the first value of current, the second value of current, and a third value of current are supplied to the laser power source to emit the laser light beam of the third power intensity from the laser power source,
wherein the current value obtaining means obtains a plurality of the second values of current supplied to the laser power source during the period in which the characteristic obtaining means causes the laser power source to emit the laser light beam of the second power intensity, and obtains an average current value of the plurality of the second values of current,
wherein the characteristic of the laser power source obtained by the characteristic obtaining means includes a laser efficiency value (EV) obtained by a following equation,
EV=(P2−P1)/IP2(av)
where P2 is the second power intensity, P1 is the first power intensity, and IP2(av) is the average current value of the plurality of the second values of current obtained by the current value obtaining means, and
wherein the current value determining means determines the third value of current (IP3) required to be supplied to the laser power source to emit the laser light beam of the third power intensity from the laser power source by a following equation,
IP3=(P3−P2)/EV
where P3 is the third power intensity, P2 is the second power intensity, and EV is the laser efficiency value.

43. An information recording apparatus that records information data into a recording medium by emitting a laser light beam to the recording medium, the information recording apparatus comprising:
laser light beam emitting means for emitting at least a laser light beam of first power intensity, a laser light beam of second power intensity greater than the first power intensity, and a laser light beam of third power intensity greater than the second power intensity to the recording medium; and
a laser power control device that controls a light-emitting power of a laser light beam emitted from the laser light beam emitting means, the laser power control device comprising,
characteristic obtaining means for obtaining a characteristic of the laser light beam emitting means by causing the laser light beam emitting means to emit the laser light beam of the second power intensity before recording information data into the recording medium; and
current value determining means for determining a value of current required to be supplied to the laser light beam emitting means to emit the laser light beam of the third power intensity from the laser light beam emitting means based on the characteristic of the laser light beam emitting means obtained by the characteristic obtaining means.

44. The information recording apparatus according to claim 43, wherein the characteristic obtaining means causes the laser light beam emitting means to emit the laser light beam of the second power intensity continuously during a predetermined period.

45. The information recording apparatus according to claim 43, wherein the characteristic obtaining means comprises current value obtaining means for obtaining a plurality of values of current supplied to the laser light beam emitting means during a period in which the characteristic obtaining means causes the laser light beam emitting means to emit the laser light beam of the second power intensity, and for obtaining an average current value of the plurality of values of current, and the characteristic obtaining means obtains the characteristic of the laser light beam emitting means based on the average current value obtained by the current value obtaining means.

46. The information recording apparatus according to claim 43, wherein the characteristic obtaining means causes the laser light beam emitting means to emit the laser light beam of the second power intensity to a light-emitting power calibration area provided in the recording medium to be used for determining an optimum recording condition for recording information data into the recording medium.

47. The information recording apparatus according to claim 45, wherein a first value of current is supplied to the laser light beam emitting means to emit the laser light beam of the first power intensity from the laser light beam emitting means, the first value of current and a second value of current are supplied to the laser light beam emitting means to emit the laser light beam of the second power intensity from the laser light beam emitting means, and the first value of current, the second value of current, and a third value of current are supplied to the laser light beam emitting means to emit the laser light beam of the third power intensity from the laser light beam emitting means,
wherein the current value obtaining means obtains a plurality of the second values of current supplied to the laser light beam emitting means during the period in which the characteristic obtaining means causes the laser light beam emitting means to emit the laser light beam of the second power intensity, and for obtaining an average current value of the plurality of the second values of current,
wherein the characteristic of the laser light beam emitting means obtained by the characteristic obtaining means includes a laser efficiency value (EV) obtained by a following equation,
EV=(P2−P1)/IP2(av)
where P2 is the second power intensity, P1 is the first power intensity, and IP2(av) is the average current value of the plurality of the second values of current obtained by the current value obtaining means, and
wherein the current value determining means determines the third value of current (IP3) required to be supplied to the laser light beam emitting means to emit the laser light beam of the third power intensity from the laser light beam emitting means by a following equation,
IP3=(P3−P2)/EV
where P3 is the third power intensity, P2 is the second power intensity, and EV is the laser efficiency value.

48. The information recording apparatus according to claim 46, further comprising optimum recording power intensity value determining means for determining an optimum recording power intensity value of the laser light beam emitted from the laser light beam emitting means by recording test data on the light-emitting power calibration area and by reproducing the test data, the optimum recording power intensity value determining means recording the test data on the light-emitting power calibration area with a plurality of laser light beams each having a different power intensity that is emitted from the laser light beam emitting means based on the value of current determined by the current value determining means.

49. The information recording apparatus according to claim 48, wherein the optimum recording power intensity value determining means records the test data on the light-emitting power calibration area with at least the laser light beam of the third power intensity by variously changing the value of the third power intensity which corresponds to the value of current determined by the current value determining means.

50. An optical disk apparatus, comprising:
laser light beam emitting means for emitting a digitally modulated laser light beam to an optical recording medium including a light-emitting power calibration area that is used for determining an optimum recording power intensity value of the laser light beam emitted from the laser light beam emitting means and that includes a test area including a plurality of partitions into which test data is recorded and includes a count area including a plurality of partitions corresponding to the partitions of the test area, the laser light beam emitted from the laser light beam emitting means including a laser light beam of first power intensity, a laser light beam of second power intensity greater than the first power intensity, and a laser light beam of third power intensity greater than the second power intensity;
driving means for driving the laser light beam emitting means by supplying current to the laser light beam emitting means;
light-emitting power detecting means for detecting a light-emitting power of the laser light beam emitted from the laser light beam emitting means;
power intensity adjusting means for adjusting a power intensity of the laser light beam emitted from the laser light beam emitting means based on the light-emitting power detected by the light-emitting power detecting means by changing a value of the current supplied to the laser light beam emitting means by the driving means;
optimum recording power intensity value determining means for determining the optimum recording power intensity value of the laser light beam emitted from the laser light beam emitting means by recording the test data into one of the partitions of the test area while changing the light-emitting power of the laser light beam emitted from the laser light beam emitting means, and by reproducing the test data; and
characteristic obtaining means for obtaining a characteristic of the laser light beam emitting means by causing the laser light beam emitting means to emit the laser light beam of the second power intensity to the one of the partitions of the test area before recording the test data into the one of the partitions,
wherein the light-emitting power of the laser light beam emitted from the laser light beam emitting means when recording the test data into the one of the partitions of the test area is obtained based on the characteristic of the laser light beam emitting means obtained by the characteristic obtaining means.

51. The optical disk apparatus according to claim 50,
wherein the optimum recording power intensity value determining means determines the optimum recording power intensity value of the laser light beam emitted from the laser light beam emitting means by recording the test data into the one of the partitions of the test area with at least the laser light beam of the third power intensity emitted from the laser light beam emitting means while variously changing the value of the third power intensity, and
wherein a value of current required to be supplied to the laser light beam emitting means by the driving means to emit the laser light beam of the third power intensity when recording the test data into the one of the partitions of the test area for determining the optimum recording power intensity value is determined based on the characteristic of the laser light beam emitting means obtained by the characteristic obtaining means.

52. The optical disk apparatus according to claim 51, further comprising current value determining means for determining a value of current required to be supplied to the laser light beam emitting means to emit the laser light beam of the third power intensity from the laser light beam emitting means based on the characteristic of the laser light beam emitting means obtained by. the characteristic obtaining means,
wherein the characteristic obtaining means comprises current value obtaining means for obtaining a plurality of values of current supplied to the laser light beam emitting means during a period in which the characteristic obtaining means causes the laser light beam emitting means to emit the laser light beam of the second power intensity, and for obtaining an average current value of the plurality of values of current, and the characteristic obtaining means obtains the characteristic of the laser light beam emitting means based on the average current value obtained by the current value obtaining means,
wherein a first value of current is supplied to the laser light beam emitting means to emit the laser light beam of the first power intensity from the laser light beam emitting means, the first value of current and a second value of current are supplied to the laser light beam emitting means to emit the laser light beam of the second power intensity from the laser light beam emitting means, and the first value of current, the second value of current, and a third value of current are supplied to the laser light beam emitting means to emit the laser light beam of the third power intensity from the laser light beam emitting means,
wherein the current value obtaining means obtains a plurality of the second values of current supplied to the laser light beam emitting means during a period in which the characteristic obtaining means causes the laser light beam emitting means to emit the laser light beam of the second power intensity, and obtains an average current value of the plurality of the second values of current,
wherein the characteristic of the laser light beam emitting means obtained by the characteristic obtaining means includes a laser efficiency value (EV) obtained by a following equation,
EV=(P2−P1)/IP2(av)
where P2 is the second power intensity, P1 is the first power intensity, and IP2(av) is the average current value of the plurality of the second values of current obtained by the current value obtaining means, and
wherein the current value determining means determines the third value of current (IP3) required to be supplied to the laser light beam emitting means to emit the laser light beam of the third power intensity from the laser light beam emitting means by a following equation,
IP3=(P3−P2)/EV
where P3 is the third power intensity, P2 is the second power intensity, and EV is the laser efficiency value.

53. The optical disk apparatus according to claim 50, wherein the second power intensity of the laser light beam functions as a DC erase power, and the DC erase power of the laser light beam emitted from the laser light beam emitting means to the one of the partitions of the test area before recording the test data into the one of the partitions is changed according to a type of the optical recording medium.

54. The optical disk apparatus according to claim 50, wherein the second power intensity of the laser light beam functions as a DC erase power, and the DC erase power of the laser light beam emitted from the laser light beam emitting means to the one of the partitions of the test area before recording the test data into the one of the partitions is changed according to a recording speed when the optimum recording power intensity value determining means records the test data into one of the partitions of the test area.

55. The optical disk apparatus according to claim 50, wherein the second power intensity of the laser light beam functions as a DC erase power, and the characteristic obtaining means causes the laser light beam emitting means to emit the laser light beam of the DC erase power to the one of the partitions of the test area at a predetermined erasing speed before recording the test data into the one of the partitions, and wherein the erasing speed is set to be equal to a speed of recording the test data into the one of the partitions.
